(19) United States
(12) Patent Application Publication
(10) Pub. No.: US 2018/0205419 A1
(43) Pub. Date: Jul. 19, 2018

(54) COORDINATED BEAMFORMING GROUPS

(71) Applicant: QUALCOMM Incorporated, San Diego, CA (US)

(72) Inventors: Yan Zhou, San Diego, CA (US); George Cherian, San Diego, CA (US); Alfred Asterjadhi, San Diego, CA (US); Venkata Ramanan Venkatachalam Jayaraman, San Diego, CA (US); Abhishek Pramod Patil, San Diego, CA (US)

(21) Appl. No.: 15/872,526

(22) Filed: Jan. 16, 2018

Related U.S. Application Data
(60) Provisional application No. 62/447,292, filed on Jan. 17, 2017.

(51) Int. Cl. H04B 7/04; H01Q 3/26; H04B 7/0417

(52) U.S. Cl. CPC H04B 7/046; H04B 7/0617; H04B 7/0417; H01Q 3/2611

(57) ABSTRACT

Various aspects of the disclosure relate to beamforming communication using coordination among a group of apparatuses. For example, a plurality of access points may coordinate to form a beamforming group.

### CROSS-REFERENCE TO RELATED APPLICATION(S)

This application claims priority to and the benefit of provisional patent application No. 62/447,292 filed in the U.S. Patent and Trademark Office on Jan. 17, 2017, the entire content of which is incorporated herein by reference.

### INTRODUCTION

Various aspects described herein relate to wireless communication and, more particularly but not exclusively, to beamformed communication involving coordination among groups of apparatuses.

Some types of wireless communication devices employ beamforming to provide a higher level of performance. One example is a millimeter wave (mmW) system that can send and receive beamformed signals at mmW frequencies (e.g., in the range of 30 GHz, 60 GHz, etc.).

FIG. 1 illustrates a communication system 100 where a mmW access point (e.g., a base station) 102 communicates with a first mmW station (STA) 104 and a second mmW STA 106 via different beamforming directions. As indicated by a set of beams 108, the mmW access point 102 may communicate via any one of a plurality of directional beams. As indicated by a set of beams 110, the first mmW STA 104 may communicate via any one of a plurality of directional beams. As indicated by a set of beams 112, the second mmW STA 106 may communicate via any one of a plurality of directional beams. For example, the access point 102 may communicate with the first mmW STA 104 via a first beamforming direction 114 and communicate with the second mmW STA 106 via a second beamforming direction 116.

A wireless multiple-in-multiple-out (MIMO) system (e.g., a wireless local area network (WLAN) that supports IEEE 802.11ax or some other 802.11 standard) may use multiple transmit antennas to provide beamforming-based signal transmission. Typically, beamforming-based signals transmitted from different antennas are adjusted in phase (and optionally amplitude) such that the resulting signal power is focused toward a receiver device (e.g., a STA).

A wireless MIMO system may support communication for a single user at a time or for several users concurrently. Transmissions to a single user (e.g., a single STA) are commonly referred to as single-user MIMO (SU-MIMO), while concurrent transmissions to multiple users (e.g., multiple STAs) are commonly referred to as multi-user MIMO (MU-MIMO).

An access point of a MIMO system employs multiple antennas for data transmission and reception, while each user employs one or more antennas. The access point communicates with the users via forward link channels and reverse link channels. In some aspects, a forward link (or downlink) channel refers to a communication channel from a transmit antenna of the access point to a receive antenna of a user, and a reverse link (or uplink) channel refers to a communication channel from a transmit antenna of a user to a receive antenna of the access point.

MIMO channels corresponding to transmissions from a set of transmit antennas to a receive antenna are referred to spatial streams since precoding (e.g., beamforming) is employed to direct the transmissions toward the receive antenna. Consequently, in some aspects, each spatial stream corresponds to at least one dimension. A MIMO system thus provides improved performance (e.g., higher throughput and/or greater reliability) through the use of the additional dimensionalities provided by these spatial streams.

In some scenarios, several access points may be located in the same area. To mitigate interference between the access points (and their associated users) and to use resources as efficiently as possible, it may be desirable for these devices to coordinate their use of the resources.

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

In some aspects, the disclosure provides an apparatus configured for communication. The apparatus includes an interface and a processing system. In some aspects, the interface is configured to obtain spatial dimension usage information of at least one other apparatus. In addition, the processing system is configured to: determine whether to perform an operation associated with a beamforming group, wherein the determination is based on the spatial dimension usage information, and generate a request to perform the operation if the determination is to perform the operation. In some aspects, the interface is further configured to output the request for transmission. In some implementations, separate interfaces could be used to obtain the spatial dimension usage information and to output the request for transmission.

In some aspects, the disclosure provides a method of communication for an apparatus. The method includes: obtaining spatial dimension usage information of at least one other apparatus; determining whether to perform an operation associated with a beamforming group, wherein the determination is based on the spatial dimension usage information; generating a request to perform the operation if the determination is to perform the operation; and outputting the request for transmission.

In some aspects, the disclosure provides an apparatus configured for communication. The apparatus includes: means for obtaining spatial dimension usage information of at least one other apparatus; means for determining whether to perform an operation associated with a beamforming group, wherein the determination is based on the spatial dimension usage information; means for generating a request to perform the operation if the determination is to perform the operation; and means for outputting the request for transmission.

In some aspects, the disclosure provides a wireless node. The wireless node includes: a receiver configured to receive spatial dimension usage information of at least one other apparatus; a processing system configured to: determine whether to perform an operation associated with a beamforming group, wherein the determination is based on the spatial dimension usage information, and generate a request to perform the operation if the determination is to perform the operation; and a transmitter configured to transmit the request.

In some aspects, the disclosure provides a computer-readable medium (e.g., a non-transitory computer-readable medium) storing computer-executable code, including code to: obtain spatial dimension usage information of at least one apparatus; determine whether to perform an operation associated with a beamforming group, wherein the determination is based on the spatial dimension usage information; generate a request to perform the operation if the determination is to perform the operation; and output the request for transmission.

In some aspects, the disclosure provides an apparatus configured for communication. The apparatus includes an interface and a processing system. In some aspects, the interface is configured to obtain reuse information of at least one wireless node served by at least one other apparatus. In addition, the processing system is configured to: determine whether to perform an operation associated with a beamforming group, wherein the determination is based on the reuse information, and generate a request to perform the operation if the determination is to perform the operation. In some aspects, the interface is further configured to output the request for transmission. In some implementations, separate interfaces could be used to obtain the reuse information and to output the request for transmission.

In some aspects, the disclosure provides a method of communication for an apparatus. The method includes: obtaining reuse information of at least one wireless node served by at least one other apparatus; determining whether to perform an operation associated with a beamforming group, wherein the determination is based on the reuse information; generating a request to perform the operation if the determination is to perform the operation; and outputting the request for transmission.

In some aspects, the disclosure provides an apparatus configured for communication. The apparatus includes: means for obtaining reuse information of at least one wireless node served by at least one other apparatus; means for determining whether to perform an operation associated with a beamforming group, wherein the determination is based on the reuse information; means for generating a request to perform the operation if the determination is to perform the operation; and means for outputting the request for transmission.

In some aspects, the disclosure provides a wireless node. The wireless node includes: a receiver configured to receive reuse information of at least one first wireless node served by at least one second wireless node; a processing system configured to: determine whether to perform an operation associated with a beamforming group, wherein the determination is based on the reuse information, and generate a request to perform the operation if the determination is to perform the operation; and a transmitter configured to transmit the request.

In some aspects, the disclosure provides a computer-readable medium (e.g., a non-transitory computer-readable medium) storing computer-executable code, including code to: obtain reuse information of at least one wireless node served by at least one apparatus; determine whether to perform an operation associated with a beamforming group, wherein the determination is based on the reuse information; generate a request to perform the operation if the determination is to perform the operation; and output the request for transmission.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations it should be understood that such implementations can be implemented in various devices, systems, and methods.

### BRIEF DESCRIPTION OF THE DRAWINGS

The accompanying drawings are presented to aid in the description of aspects of the disclosure and are provided solely for illustration of the aspects and not limitations thereof.

FIG. 1 illustrates an example of a wireless communication system in which aspects of the present disclosure may be employed.

FIG. 2 illustrates another example of a wireless communication system in which aspects of the present disclosure may be employed.

FIG. 3 illustrates an example of a group of access points (APs) in accordance with some aspects of the disclosure.

FIG. 4 illustrates an example of a coordinated beamforming schedule in accordance with some aspects of the disclosure.

FIG. 5 illustrates an example of a beamforming group in accordance with some aspects of the disclosure.

FIG. 6 illustrates an example of a time division multiplexed schedule.

FIG. 7 illustrates an example of a coordinated beamforming schedule in accordance with some aspects of the disclosure.

FIG. 8 illustrates an example of signaling for forming a beamforming group in accordance with some aspects of the disclosure.

FIG. 9 illustrates an example of a beamforming group in accordance with some aspects of the disclosure.

FIG. 10 illustrates an example of signaling for joining a beamforming group in accordance with some aspects of the disclosure.

FIG. 11 illustrates an example of a beamforming group in accordance with some aspects of the disclosure.

FIG. 12 illustrates an example of a time division multiplexed schedule.

FIG. 13 illustrates an example of a coordinated beamforming schedule in accordance with some aspects of the disclosure.

FIG. 14 illustrates an example of signaling for forming a beamforming group in accordance with some aspects of the disclosure.

FIG. 15 illustrates an example of a wireless communication system in which aspects of the present disclosure may be employed.

FIG. 16 is a functional block diagram of an example apparatus that may be employed within a wireless communication system in accordance with some aspects of the disclosure.

FIG. 17 is a functional block diagram of example components that may be utilized in the apparatus of FIG. 16 to transmit wireless communication.

FIG. 18 is a functional block diagram of example components that may be utilized in the apparatus of FIG. 16 to receive wireless communication.

FIG. 19 is a functional block diagram of an example apparatus in accordance with some aspects of the disclosure.

FIG. 20 is a flow diagram of an example request process based on spatial dimension usage in accordance with some aspects of the disclosure.

FIG. 21 is a flow diagram of an example request process based on reuse in accordance with some aspects of the disclosure.

FIG. 22 is a simplified block diagram of several sample aspects of an apparatus configured with spatial dimension usage-based request functionality in accordance with some aspects of the disclosure.

FIG. 23 is a simplified block diagram of several sample aspects of an apparatus configured with reuse-based request functionality in accordance with some aspects of the disclosure.

FIG. 24 is a simplified block diagram of several sample aspects of a memory configured with code for a spatial dimension usage-based request in accordance with some aspects of the disclosure.

FIG. 25 is a simplified block diagram of several sample aspects of a memory configured with code for a reuse-based request in accordance with some aspects of the disclosure.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may include at least one element of a claim. As an example of the above, in some aspects, a method of communication includes obtaining spatial dimension usage information of at least one other apparatus, determining whether to perform an operation associated with a beamforming group (where the determination is based on the spatial dimension usage information), generating a request to perform the operation if the determination is to perform the operation, and outputting the request for transmission.

The disclosure relates in some aspects to beamforming communication using coordination among a group of apparatuses. For example, a plurality of access points (APs) may coordinate to form a beamforming group. The disclosure relates in some aspects to using coordinated beamforming grouping in scenarios where a gain in resource usage or channel quality is expected.

In a first technique, dimension-underutilized APs can be grouped for coordinated beamforming. In some aspects, coordinated beamforming may fully utilize AP dimensions by grouping multiple dimension-underutilized APs together in same time slot. In this case, additional AP dimensions are used to form nulls to the stations (STAs) of other APs (e.g., other basic service sets, BSSs) of the beamforming group.

In a second technique, APs with reuse STAs can be grouped for coordinated beamforming. In some aspects, coordinated beamforming can serve more STAs than time division multiplexed (TDMed) downlink (DL) MU scheduling by reusing dimensions across BSSs.

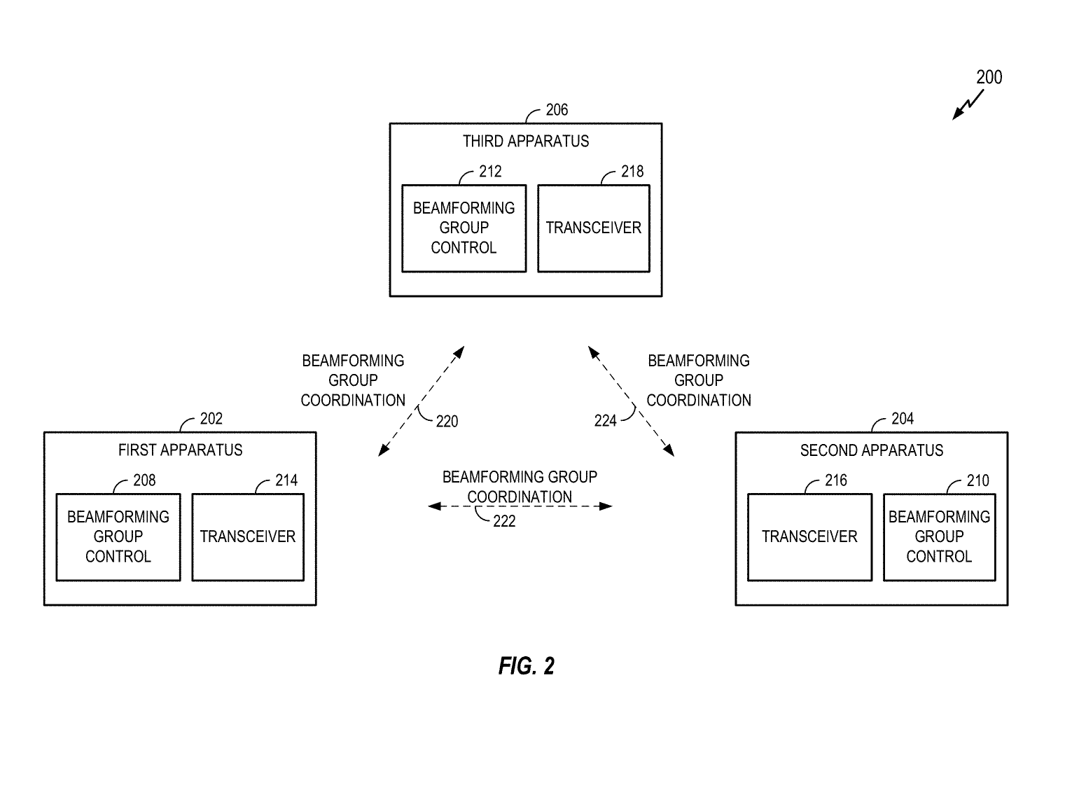

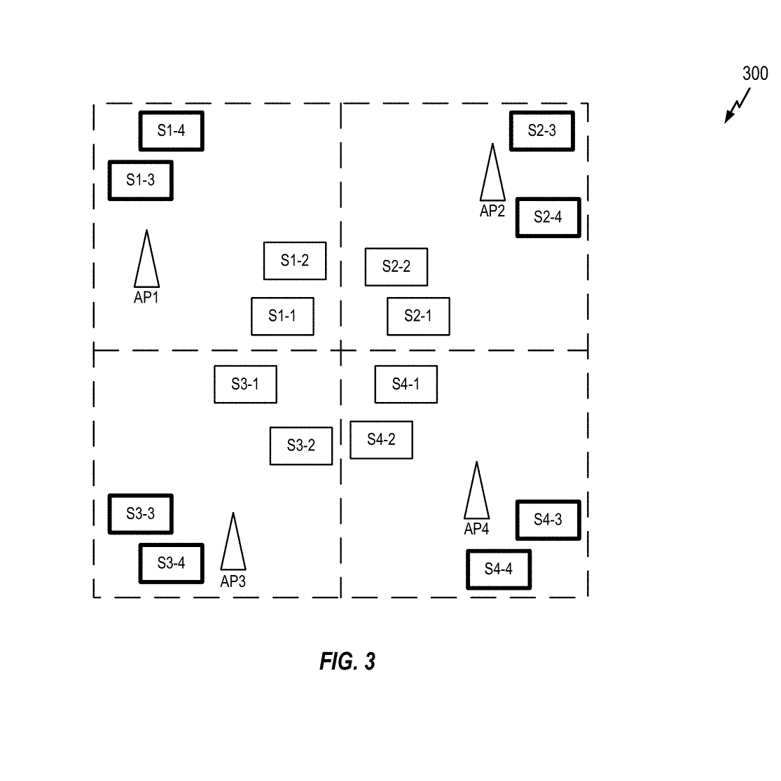

FIG. 2 illustrates a wireless communication system 200 where a first apparatus 202, a second apparatus 204, and a third apparatus 206 coordinate to form a beamforming group. A different number of apparatuses could form a beamforming group in other scenarios. The first apparatus 202, the second apparatus 204, and the third apparatus 206 include beamforming group control 208, 210, or 212 and a transceiver 214, 216, or 218, respectively, to send and/or receive beamforming group coordination signals 220, 222, or 224. For example, the first apparatus 202 (e.g., an AP or a central scheduler) may receive dimension information from the second apparatus 204 (e.g., an AP) and the third apparatus 206 (e.g., an AP) to determine whether to form a beamforming group. As another example, the third apparatus 206 may receive dimension information about a beamforming group from the first apparatus 202 (e.g., a beamforming group leader) to determine whether to join the beamforming group. These and other aspects of beamforming coordination in accordance with the teachings herein will now be described in more detail with reference to FIGS. 3-14.

### Coordinated Beamforming

FIG. 3 illustrates an example wireless communication system 300 where four APs (AP1, AP2, AP3, and AP4) form a group for coordinated beamforming transmission (Tx). In this example, each AP has four stations (STAs) in its basis service set (BSS). For example, AP1 serves STAs S1-1, S1-2, S1-3, and S1-4, AP2 serves STAs S2-1, S2-2, S2-3, and S2-4, AP3 serves STAs S3-1, S3-2, S3-3, and S3-4, and AP4 serves STAs S4-1, S14-2, S14-3, and S4-4. Each AP has at least four antennas (four dimensions). Each STA has single antenna. Other configurations could be used in other scenarios.

In some aspects, there may be two categories of STAs. STAs of the first category may be referred to as reuse STAs. STAs of the second category may be referred to as non-reuse STAs.

Reuse STAs (the boxes with thicker lines) have a sufficient signal-to-interference-and-noise ratio (SINR) to be served simultaneously without being nulled by any overlapping BSS (OBSS) AP in the beamforming group. The reuse STAs in FIG. 3 are designated as STAs S1-3, S1-4, S2-3, S2-4, S3-3, S3-4, S4-3, and S4-4.

Non-reuse STA (the boxes without the thicker lines) are those STAs where any OBSS AP transmission may significantly degrade the SINR of these STAs. In accordance with the teachings here, the non-reuse STAs may be nulled by at least one OBSS AP. The non-reuse STAs in FIG. 3 are designated as STAs S1-1, S1-2, S2-1, S2-2, S3-1, S3-2, S4-1, and S4-2.

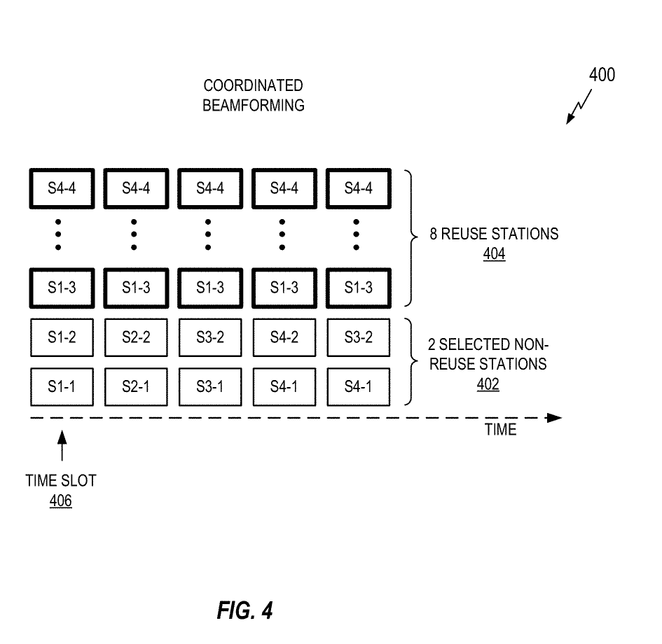

In accordance with the teachings herein, in a given coordinated beamforming Tx time slot, an AP may serve at least one reuse STA and/or at least one non-reuse STA. See, for example, the coordinate beamforming schedule 400 of FIG. 4 which illustrates scheduling of two selected non-reuse stations 402 and eight reuse stations 404 for each time slot (e.g., a first time slot 406). Each AP uses X dimensions to serve its X selected reuse STAs (X=2 in the example of FIG. 3). Each AP uses its remaining Y dimensions to serve or null Y selected non-reuse STAs (Y=2 in the example of FIG. 3).

### Coordinated Beamforming Grouping Techniques

The disclosure relates in some aspects to two coordinate beamforming (COBF) grouping techniques.

In a first technique, so-called “dimension-underutilized” APs can be grouped for COBF. In some aspects, COBF fully utilizes AP dimensions by grouping multiple dimension-underutilized APs together in the same time slot. Additional AP dimensions form nulls to OBSS STAs.

In a second technique, APs with reuse STAs can be grouped for COBF. In some aspects, COBF may serve more STAs than time division multiplexed (TDMed) DL MU communication by reusing dimensions across BSSs.

### Coordinated Beamforming Based on Dimension Usage Information

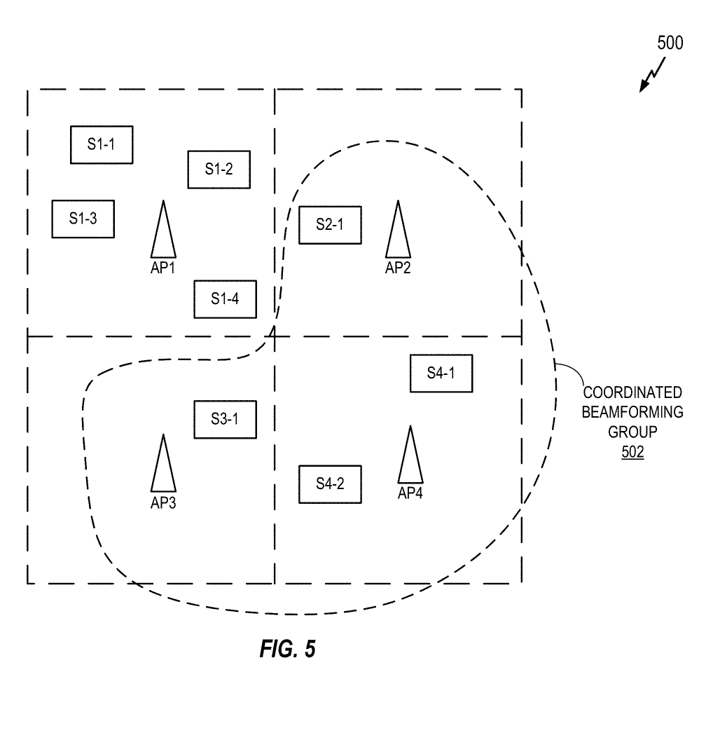

APs that have underutilized dimensions can be grouped for COBF. FIG. 5 illustrates a wireless communication system 500 with a grouping example where there are fewer STAs than available dimensions in some of the BSSs. These BSSs may thus be considered underutilized. In the example of FIG. 5, AP1 is using 4 dimensions (and is thus fully utilized). In contrast, AP2 is using one dimension, AP 2 is using one dimension, and AP 4 is using two dimensions. Thus, as AP2, AP3, and AP4 are underutilized, it may be advantageous for these APs to form a coordinated beamforming group 502 as shown in FIG. 5.

Grouping decision can be centralized or distributed. In the absence of a central scheduler, APs can broadcast and/or exchange dimension usage information over-the-air (OTA) to make a grouping decision. A new AP can join a group as long as the group still has underutilized dimensions.

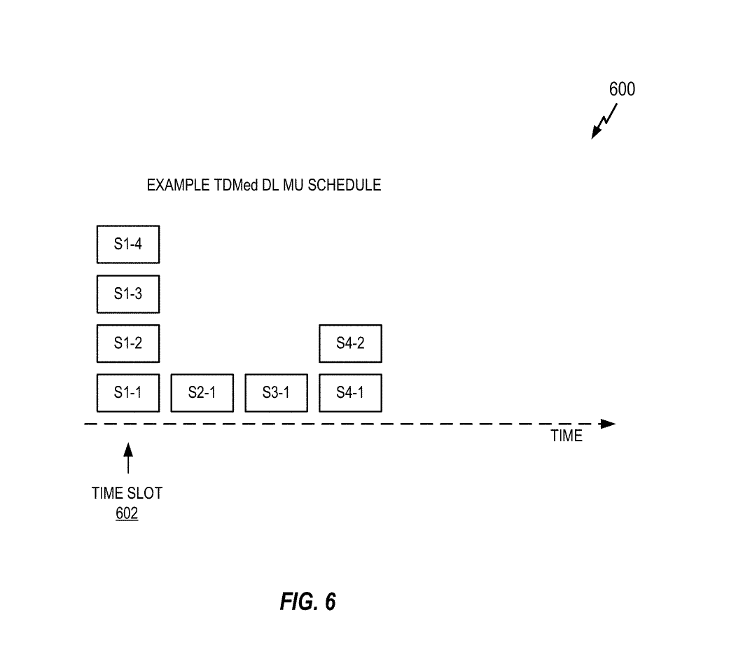

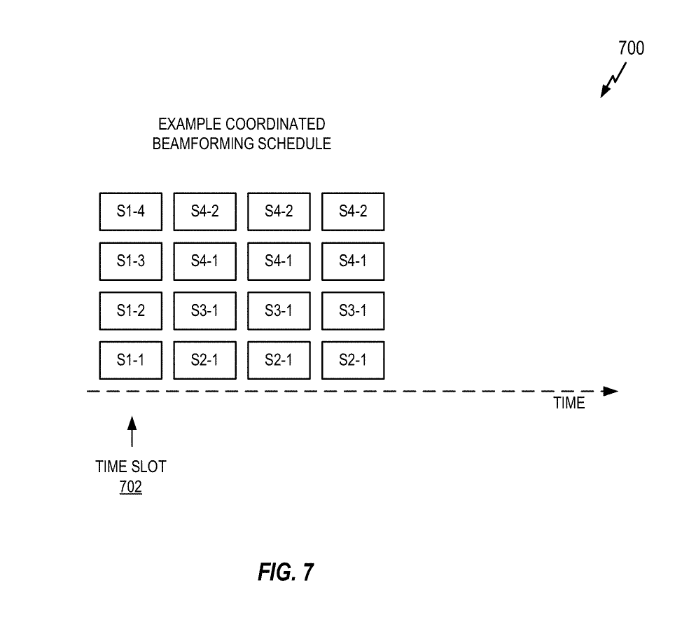

FIGS. 6 and 7 illustrate that COBF group scheduling may use resources more efficiently than TDM scheduling. Again, it is assumed that each AP has four dimensions.

FIG. 6 illustrates a scheduling pattern 600 for a TDMed DL MU scenario. In this case, the BSSs are TDMed onto the time slots (e.g., a first time slot 602). As indicated in FIG. 6, the spatial dimensions are not fully utilized for AP 2, AP3, and AP4 in this example.

FIG. 7 illustrates a scheduling pattern 700 for a COBF scenario. The COBF group includes AP2, AP3, and AP4 as shown in FIG. 5. In this case, AP1 (BSS1) is TDMed with the COBF group. As shown, spatial dimensions are fully utilized at any time slot in this example (e.g., a first time slot 702). Accordingly, the sum throughput is higher in this scenario as compared to the TDMed scenario.

In accordance with the teachings herein, APs may exchange dimension information to form a group. For example, each AP not in any COBF group may send the dimension usage information to other APs to decide whether to form a group. First and second types of dimension usage information are set forth below. Other types could be used.

A first type of dimension usage information may be for a Single BSS MU utilized dimension. Examples of this type of information include the mean, the maximum, or an X percentile of used dimensions in DL and/or UL MU PPDUs in a certain time window in the AP's BSS.

A second type of dimension usage information may be for a Single BSS MU maximum dimension. This refers to the maximum dimension in DL and/or UL MU PPDUs in the AP's BSS.

Both types of information may be used by APs that are not in a beamforming group to decide whether to form a new COBF group.

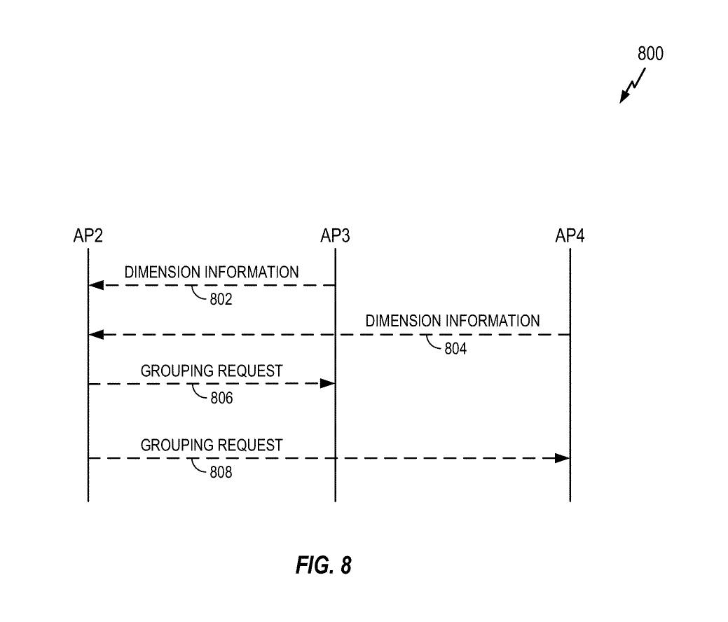

FIG. 8 illustrates an example of a signaling flow 800 that may be used by APs to form a beamforming group. Initially, AP2, AP3, and AP4 are not in any group.

As shown, AP2 collects dimension information 802 broadcasted by AP3 and dimension information 804 broadcasted by AP4. The dimension information could be, for example, the first and/or second type of information described above (Single BSS MU utilized dimension and/or Single BSS MU maximum dimension).

AP2 may send grouping requests if dimension usage can be improved by forming a COBF group with AP2, AP3, and AP4. In FIG. 8, AP2 sends a grouping request 806 to AP3 and a grouping request 808 to AP4. In some aspects, AP2 may send the grouping requests based on the dimension information received by AP2. For example, AP2 may elect to form a group if the sum of the MU utilized dimensions is less than or equal to the minimum of MU maximum dimensions. If this is true, this implies that single BSS MU dimensions are underutilized at any AP.

In accordance with the teachings herein, APs may exchange dimension information to join an existing group. For example, each AP in the COBF group may send dimension usage information to other APs to enable the other APs to decide whether to join the group. Third and fourth types of dimension usage information are set forth below. Other types could be used.

A third type of dimension usage information may be for a COBF group utilized dimension. Examples of this type of information include the mean, the maximum, or a percentile (X%ile) of used dimensions in COBF transmission in a certain time window in the AP's COBF group.

A fourth type of dimension usage information may be for a COBF group maximum dimension. This refers to the maximum dimension in the DL and/or UL COBF Tx in the AP's group. This information may computed as the minimum of DL and/or UL single BSS MU maximum dimension across all APs in the group.

Both types of information may be used by APs that are not in a beamforming group to decide whether to join a COBF group.

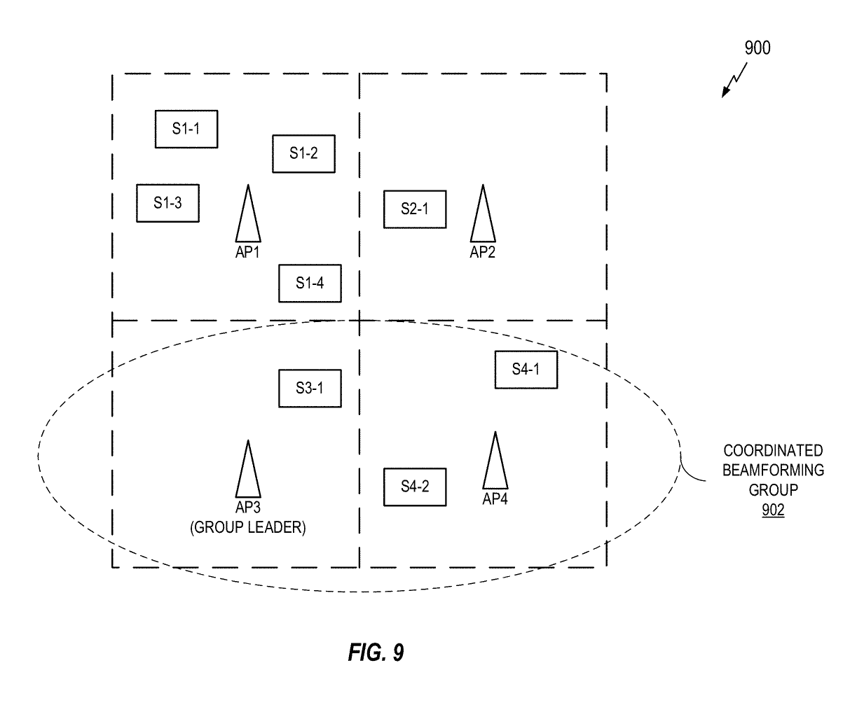

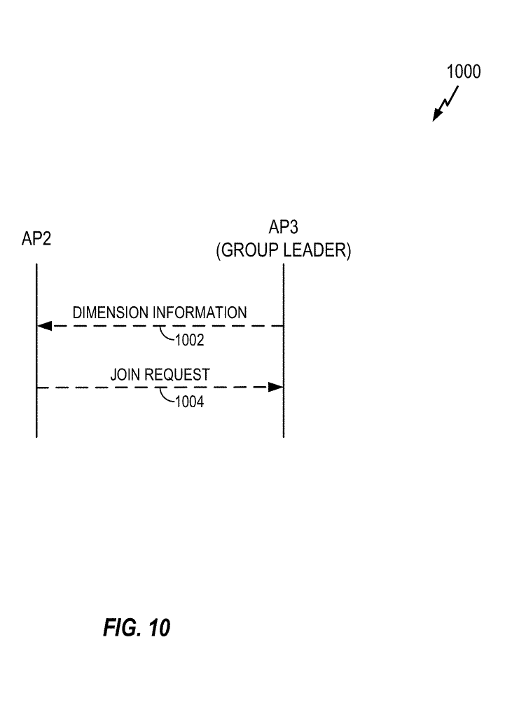

FIGS. 9 and 10 illustrate an example of an AP joining a beamforming group. Initially, AP2 is not in any group and AP3 and AP4 form an existing group 902 as shown in the wireless communication system 900 of FIG. 9.

FIG. 10 illustrates an example of a signaling flow 1000 where AP2 requests to join the beamforming group. AP 2 may collect group dimension information 1002 broadcasted by a group leader (AP 3 in the example of FIG. 9). The dimension information could be, for example, the third and/or further type of information described above (COBF group utilized dimension and COBF group max dimension).

AP2 may send a join request 1004 if the group dimension usage can increase. In some aspects, AP2 may send a join request based on the dimension information received by AP2. For example, the request may be sent if AP2's MU utilized dimension plus the group's utilized dimension is less than or equal to the minimum of the MU maximum dimensions of AP2, AP3, and AP4. This implies that if AP2 joins the group, the utilized dimensions of the group will increase.

An AP in a group may decide to leave the group if the AP can fully or almost fully utilize its dimensions when operating in single BSS DL and/or UL MU Tx mode. By leaving the COBF group, the AP may reduce (e.g., eliminate) coordination overhead for this AP that could otherwise be required if the AP were to remain in the COBF group. For example, an AP may leave a COBF group if the AP's estimated single BSS MU utilized dimension is close to the AP's single BSS MU maximum dimension. Although an AP in a COBF group might not perform single BSS DL and/or UL MU Tx, the AP may still estimate the used dimensions for MU Tx. For example, in every Tx, the AP can compute how many dimensions can be scheduled if using DL and/or UL MU Tx. Further to the above, it might not be beneficial for an AP to join a COBF group if the AP's dimension is already fully used in single BSS MU Tx (unless there is COBF reuse gain). However, once an AP participates in COBF, the AP does not do single BSS MU Tx anymore, so the AP has to estimate what the dimension usage would be if the AP were operating in single BSS MU Tx. If estimated usage is high, the AP may decide to leave COBF to save coordination overhead.

### Coordinated Beamforming Based on Reuse Station Information

APs can be grouped for COBF if the APs have reuse STAs. In some aspects, reuse STAs will be those that are relatively far from other APs in the group and/or are located such that the beam from the AP will not significantly interfere with the STAs of the other APs of the group. The dimensions of the APs can then be reused for the reuse STAs.

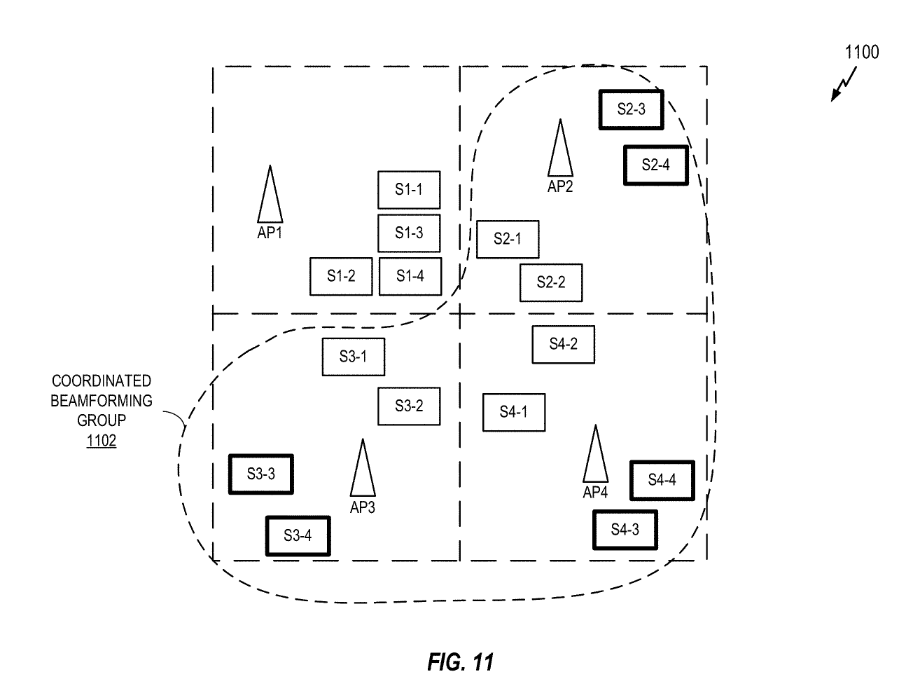

FIG. 11 illustrates a wireless communication system 1100 with a grouping example where some of the APs have reuse STAs. Transmission for these STA may thus be scheduled in the same time slot. In the example of FIG. 11, AP1 is using 4 dimensions with no reuse STAs. In contrast, AP2 has two STAs (S2-3 and S2-4) reusable with AP3 and AP4, AP3 has two STAs (S3-3 and S3-4) reusable with AP2 and AP4, and AP4 has two STAs (S4-3 and S4-4) reusable with AP2 and AP3. Thus, it may be advantageous for AP2, AP3, and AP4 to form a coordinated beamforming group 1102 as shown in FIG. 11.

A grouping decision can be centralized or distributed. In the absence of a central scheduler, APs can broadcast and/or exchange information regarding reuse STAs OTA to make a grouping decision.

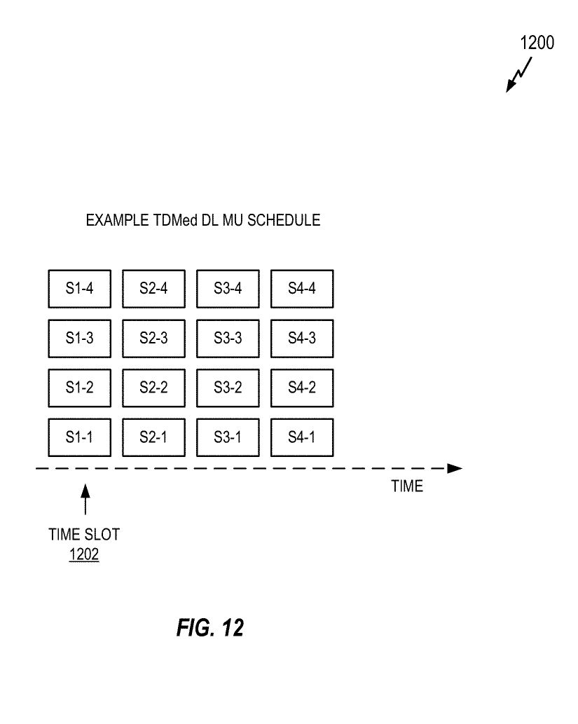

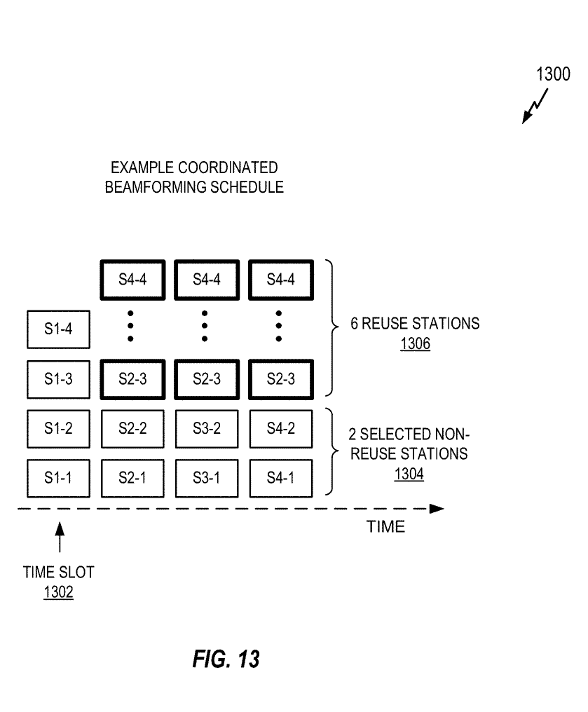

FIGS. 12 and 13 illustrate that COBF group scheduling may use resources more efficiently than TDM scheduling. Again, it is assumed that each AP has four dimensions.

FIG. 12 illustrates a scheduling pattern 1200 for a TDMed DL MU scenario. In this case, the BSSs are TDMed onto the time slots (e.g., a first time slot 1202), with four dimensions used per time slot.

FIG. 13 illustrates a scheduling pattern 1300 for a COBF scenario. The COBF group includes AP2, AP3, and AP4 as shown in FIG. 11. In this case, AP1 (BSS1) is TDMed with the COBF group. As shown, eight dimensions are used per COBF time slot (e.g., a first time slot 1302). Accordingly, the sum throughput is higher in this scenario as compared to the TDM scenario of FIG. 12. In this example, the scheduling is for two selected non-reuse stations 1304 and six reuse stations 1306 for each time slot.

In accordance with the teachings herein, APs may exchange reuse STA number information to form a group. For example, each AP not in any COBF group may send the information on the reuse STA number per OBSS AP set to other APs to decide whether to form a group.

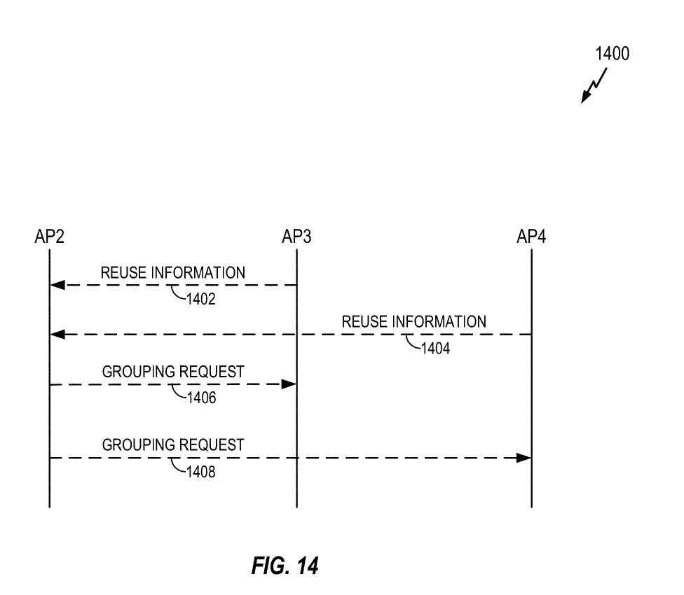

FIG. 14 illustrates an example of a signaling flow 1400 that may be used by APs to form a beamforming group. Initially, AP2, AP3, and AP4 are not in any group.

As shown, AP 2 collects dimension information 1402 broadcasted by AP3 and dimension information 1404 broadcasted by AP4. The dimension information could be, for example, the number of reuse STAs for each set of OBSS APs. For example, AP3 may indicate that it has two reuse STAs for OBSS AP2 and AP4.

AP2 may send grouping requests if dimensions can be reused by forming a COBF group with AP 2, AP3, and AP4. In the example of FIG. 14, AP2 sends a grouping request 1406 to AP3 and a grouping request 1408 to AP4. In some aspects, AP2 may send the grouping requests based on the dimension information received by AP2. For example, AP2 may elect to form a group if AP2, AP3, and AP 4 all have at least one STA they can reuse with other OBSS APs in the group.

### Example Wireless Communication System

The teachings herein may be implemented using various wireless technologies and/or various spectra. Wireless network technologies may include various types of wireless local area networks (WLANs). A WLAN may be used to interconnect nearby devices together, employing widely used networking protocols. The various aspects described herein may apply to any communication standard, such as Wi-Fi or, more generally, any member of the IEEE 802.11 family of wireless protocols (e.g., 802.11ad, 802.11ax, 802.11ay, 802.11az, etc.).

In some aspects, wireless signals may be transmitted according to an 802.11 protocol using orthogonal frequency-division multiplexing (OFDM), direct-sequence spread spectrum (DSSS) communication, a combination of OFDM and DSSS communication, single carrier, or other schemes. Certain of the devices described herein may implement a high-efficiency 802.11 standard, for example. Such devices, whether used as a STA, an AP, or another device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications. Although various systems, methods, and apparatuses are described herein with respect to a high-efficiency 802.11 standard, for example, a person having ordinary skill in the art will appreciate that the present disclosure is applicable to other wireless communication standards.

Certain of the devices described herein may further implement multi-user technology and be implemented as part of an 802.11 protocol. For example, such a device may employ orthogonal frequency domain multiple access (OFDMA) and/or multi-user MIMO (MU-MIMO). A MIMO system employs multiple (Nₜ) transmit antennas and multiple (Nᵣ) receive antennas for data transmission. A MIMO channel formed by the Nₜ transmit and Nᵣ receive antennas may be decomposed into Nₛ independent channels, which are also referred to as spatial channels or streams, where Nₛ≤min{Nₜ, Nᵣ}. Each of the Nₛ independent channels corresponds to a dimension. The MIMO system can provide improved performance (e.g., higher throughput and/or greater reliability) if the additional dimensionalities created by the multiple transmit and receive antennas are utilized.

In some implementations, a WLAN includes various devices that access the wireless network. For example, there may be two types of devices: access points (APs) and clients (also referred to as stations, or STAs). In general, an AP serves as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations, a STA may also be used as an AP.

An access point (AP) may also include, be implemented as, or known as a Transmit Receive Point (TRP), a NodeB, a gNodeB, a Radio Network Controller (RNC), an eNodeB, Base Station Controller (BSC), a Base Transceiver Station (BTS), Base Station (BS), a Radio Base Station (RBS), a Transceiver Function (TF), a Radio Router, a Radio Transceiver, a Basic Service Set (BSS), an Extended Service Set (ESS), a macro cell, a macro node, a Home eNB (HeNB), a femto cell, a femto node, a pico node, or referenced using other similar terminology.

A station (STA) may also include, be implemented as, or known as an access terminal (AT), a subscriber station, a subscriber unit, a mobile station, a remote station, a remote terminal, a user terminal, a user agent, a user device, a user equipment (UE), or some other terminology. In some implementations, STA may include, be implemented as, or known as a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a headset, a portable computing device (e.g., a personal data assistant), an entertainment device (e.g., a music or video device, or a satellite radio), a gaming device or system, a global positioning system device, a medical device, a sensor device, or any other suitable device that is configured to communicate via a wireless medium.

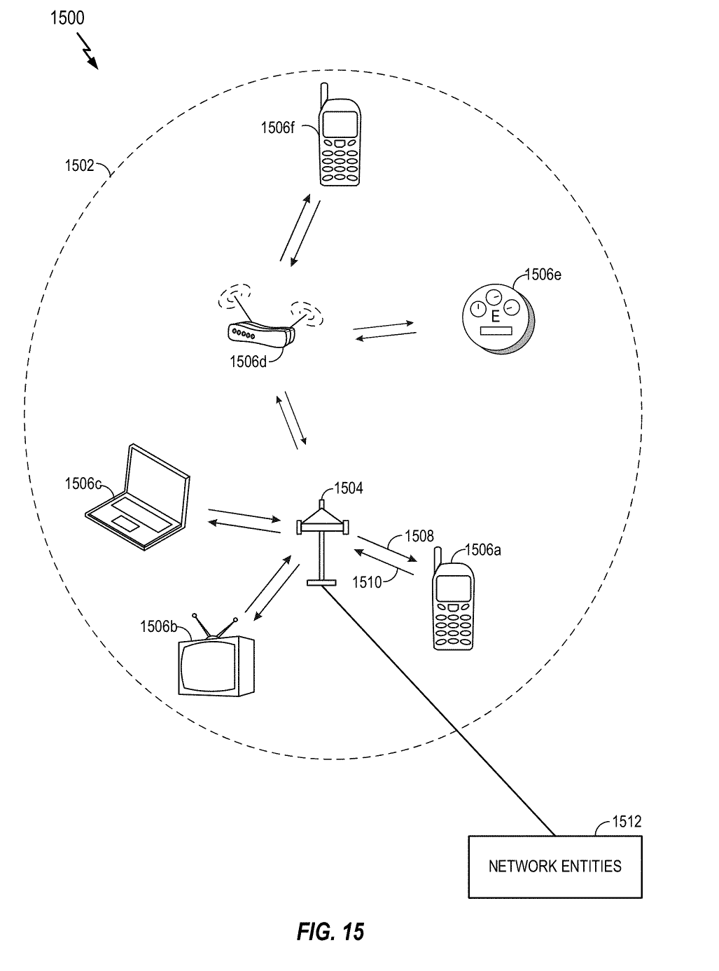

FIG. 15 illustrates an example of a wireless communication system 1500 in which aspects of the present disclosure may be employed. The wireless communication system 1500 may operate pursuant to a wireless standard, for example the 802.11 standard. The wireless communication system 1500 may include an AP 1504, which communicates with STAs 1506a, 1506b, 1506c, 1506d, 1506e, and 1506f (collectively STAs 1506).

STAs 1506e and 1506f may have difficulty communicating with the AP 1504 or may be out of range and unable to communicate with the AP 1504. As such, another STA 1506d may be configured as a relay device (e.g., a device including STA and AP functionality) that relays communication between the AP 1504 and the STAs 1506e and 1506f.

A variety of processes and methods may be used for transmissions in the wireless communication system 1500 between the AP 1504 and the STAs 1506. For example, signals may be sent and received between the AP 1504 and the STAs 1506 in accordance with OFDM/OFDMA techniques. If this is the case, the wireless communication system 1500 may be referred to as an OFDM/OFDMA system. Alternatively, signals may be sent and received between the AP 1504 and the STAs 1506 in accordance with CDMA techniques. If this is the case, the wireless communication system 1500 may be referred to as a CDMA system.

A communication link that facilitates transmission from the AP 1504 to one or more of the STAs 1506 may be referred to as a downlink (DL) 1508, and a communication link that facilitates transmission from one or more of the STAs 1506 to the AP 1504 may be referred to as an uplink (UL) 1510. Alternatively, a downlink 1508 may be referred to as a forward link or a forward channel, and an uplink 1510 may be referred to as a reverse link or a reverse channel

The AP 1504 may act as a base station and provide wireless communication coverage in a basic service area (BSA) 1502. The AP 1504 along with the STAs 1506 associated with the AP 1504 and that use the AP 1504 for communication may be referred to as a basic service set (BSS).

Access points may thus be deployed in a communication network to provide access to one or more services (e.g., network connectivity) for one or more STAs that may be installed within or that may roam throughout a coverage area of the network. For example, at various points in time a STA may connect to the AP 1504 or to some other access point in the network (not shown).

Each of the access points may communicate with one or more network entities (represented, for convenience, by network entities 1512 in FIG. 15), including each other, to facilitate wide area network connectivity. A network entity may take various forms such as, for example, one or more radio and/or core network entities. Thus, in various implementations the network entities 1512 may represent functionality such as at least one of: network management (e.g., via an authentication, authorization, and accounting (AAA) server), session management, mobility management, gateway functions, interworking functions, database functionality, or some other suitable network functionality. Two or more of such network entities may be co-located and/or two or more of such network entities may be distributed throughout a network.

It should be noted that in some implementations the wireless communication system 1500 might not have a central AP 1504, but rather may function as a peer-to-peer network between the STAs 1506. Accordingly, the functions of the AP 1504 described herein may alternatively be performed by one or more of the STAs 1506. Also, as mentioned above, a relay may incorporate at least some of the functionality of an AP and a STA.

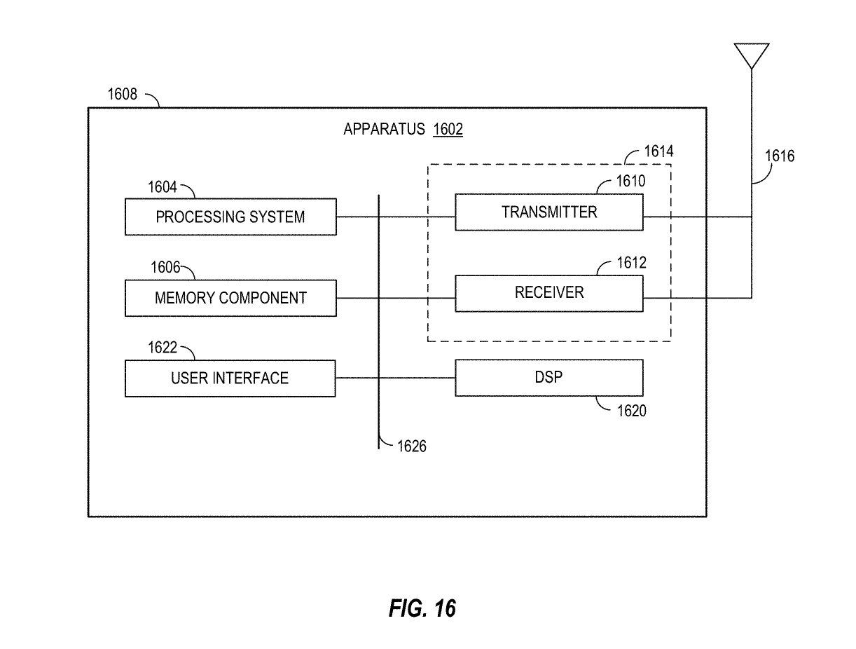

FIG. 16 illustrates various components that may be utilized in an apparatus 1602 (e.g., a wireless device) that may be employed within the wireless communication system 1500. The apparatus 1602 is an example of a device that may be configured to implement the various methods described herein. For example, the apparatus 1602 may be implemented as the AP 1504, a relay (e.g., the STA 1506d), or one of the STAs 1506 of FIG. 15.

The apparatus 1602 may include a processing system 1604 that controls operation of the apparatus 1602. The processing system 1604 may also be referred to as a central processing unit (CPU). A memory component 1606 (e.g., including a memory device), which may include both read-only memory (ROM) and random access memory (RAM), provides instructions and data to the processing system 1604. A portion of the memory component 1606 may also include non-volatile random access memory (NVRAM). The processing system 1604 typically performs logical and arithmetic operations based on program instructions stored within the memory component 1606. The instructions in the memory component 1606 may be executable to implement the methods described herein.

When the apparatus 1602 is implemented or used as a transmitting node, the processing system 1604 may be configured to select one of a plurality of media access control (MAC) header types, and to generate a packet having that MAC header type. For example, the processing system 1604 may be configured to generate a packet including a MAC header and a payload and to determine what type of MAC header to use.

When the apparatus 1602 is implemented or used as a receiving node, the processing system 1604 may be configured to process packets of a plurality of different MAC header types. For example, the processing system 1604 may be configured to determine the type of MAC header used in a packet and process the packet and/or fields of the MAC header.

The processing system 1604 may be implemented as, include, or be a component of a larger processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The apparatus 1602 may also include a housing 1608 that may include a transmitter 1610 and a receiver 1612 to allow transmission and reception of data between the apparatus 1602 and a remote location. The transmitter 1610 and receiver 1612 may be combined into single communication device (e.g., a transceiver 1614). An antenna 1616 may be attached to the housing 1608 and electrically coupled to the transceiver 1614. The apparatus 1602 may also include (not shown) multiple transmitters, multiple receivers, multiple transceivers, and/or multiple antennas. A transmitter 1610 and a receiver 1612 may be implemented as an integrated device (e.g., embodied as a transmitter circuit and a receiver circuit of a single communication device) in some implementations, may be implemented as a separate transmitter device and a separate receiver device in some implementations, or may be embodied in other ways in other implementations.

The transmitter 1610 may be configured to wirelessly transmit packets having different MAC header types. For example, the transmitter 1610 may be configured to transmit packets with different types of headers generated by the processing system 1604, discussed above.

The receiver 1612 may be configured to wirelessly receive packets having different MAC header type. In some aspects, the receiver 1612 is configured to detect a type of a MAC header used and process the packet accordingly.

The receiver 1612 may be used to detect and quantify the level of signals received by the transceiver 1614. The receiver 1612 may detect such signals as total energy, energy per subcarrier per symbol, power spectral density and other signals. The apparatus 1602 may also include a digital signal processor (DSP) 1620 for use in processing signals. The DSP 1620 may be configured to generate a data unit for transmission. In some aspects, the data unit may include (e.g., may be) a physical layer data unit (PPDU). In some aspects, the PPDU is referred to as a packet.

The apparatus 1602 may further include a user interface 1622 in some aspects. The user interface 1622 may include (e.g., may be) a keypad, a microphone, a speaker, and/or a display. The user interface 1622 may include any element or component that conveys information to a user of the apparatus 1602 and/or receives input from the user.

The various components of the apparatus 1602 may be coupled together by a bus system 1626. The bus system 1626 may include a data bus, for example, as well as a power bus, a control signal bus, and a status signal bus in addition to the data bus. Those of skill in the art will appreciate the components of the apparatus 1602 may be coupled together or accept or provide inputs to each other using some other mechanism.

Although a number of separate components are illustrated in FIG. 16, one or more of the components may be combined or commonly implemented. For example, the processing system 1604 may be used to implement not only the functionality described above with respect to the processing system 1604, but also to implement the functionality described above with respect to the transceiver 1614 and/or the DSP 1620. Further, each of the components illustrated in FIG. 16 may be implemented using a plurality of separate elements. Furthermore, the processing system 1604 may be used to implement any of the components, modules, circuits, or the like described below, or each may be implemented using a plurality of separate elements.

For ease of reference, when the apparatus 1602 is configured as a transmitting node, it is hereinafter referred to as an apparatus 1602t. Similarly, when the apparatus 1602 is configured as a receiving node, it is hereinafter referred to as an apparatus 1602r. A device in the wireless communication system 1500 may implement only functionality of a transmitting node, only functionality of a receiving node, or functionality of both a transmitting node and a receive node.

As discussed above, the apparatus 1602 may be implemented as an AP 1504 or a STA 1506, and may be used to transmit and/or receive communication having a plurality of MAC header types.

The components of FIG. 16 may be implemented in various ways. In some implementations, the components of FIG. 16 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks of FIG. 16 may be implemented by processor and memory component(s) of the apparatus (e.g., by execution of appropriate code and/or by appropriate configuration of processor components). It should be appreciated that these components may be implemented in different types of apparatuses in different implementations (e.g., in an ASIC, in a system-on-a-chip (SoC), etc.).

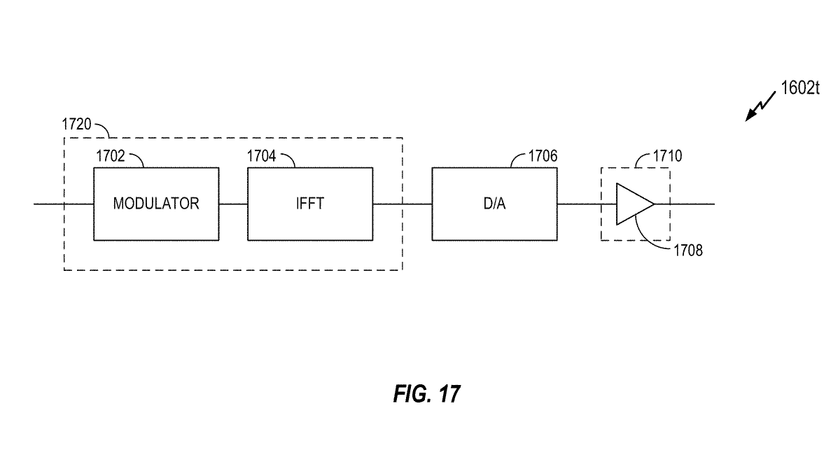

As discussed above, the apparatus 1602 may be implemented as an AP 1504 or a STA 1506, a relay, or some other type of apparatus, and may be used to transmit and/or receive communication. FIG. 17 illustrates various components that may be utilized in the apparatus 1602t to transmit wireless communication. The components illustrated in FIG. 17 may be used, for example, to transmit OFDM communication. In some aspects, the components illustrated in FIG. 17 are used to generate and transmit packets to be sent over a bandwidth of less than or equal to 1 MHz.

The apparatus 1602t of FIG. 17 may include a modulator 1702 configured to modulate bits for transmission. For example, the modulator 1702 may determine a plurality of symbols from bits received from the processing system 1604 (FIG. 16) or the user interface 1622 (FIG. 16), for example by mapping bits to a plurality of symbols according to a constellation. The bits may correspond to user data or to control information. In some aspects, the bits are received in codewords. In one aspect, the modulator 1702 may include (e.g., may be) a QAM (quadrature amplitude modulation) modulator, for example, a 16-QAM modulator or a 64-QAM modulator. In other aspects, the modulator 1702 may include (e.g., may be) a binary phase-shift keying (BPSK) modulator, a quadrature phase-shift keying (QPSK) modulator, or an 8-PSK modulator.

The apparatus 1602t may further include a transform module 1704 configured to convert symbols or otherwise modulated bits from the modulator 1702 into a time domain. In FIG. 17, the transform module 1704 is illustrated as being implemented by an inverse fast Fourier transform (IFFT) module. In some implementations, there may be multiple transform modules (not shown) that transform units of data of different sizes. In some implementations, the transform module 1704 may be itself configured to transform units of data of different sizes. For example, the transform module 1704 may be configured with a plurality of modes, and may use a different number of points to convert the symbols in each mode. For example, the IFFT may have a mode where 32 points are used to convert symbols being transmitted over 32 tones (i.e., subcarriers) into a time domain, and a mode where 64 points are used to convert symbols being transmitted over 64 tones into a time domain. The number of points used by the transform module 1704 may be referred to as the size of the transform module 1704.

In FIG. 17, the modulator 1702 and the transform module 1704 are illustrated as being implemented in the DSP 1720. In some aspects, however, one or both of the modulator 1702 and the transform module 1704 are implemented in the processing system 1604 or in another element of the apparatus 1602t (e.g., see description above with reference to FIG. 16).

As discussed above, the DSP 1720 may be configured to generate a data unit for transmission. In some aspects, the modulator 1702 and the transform module 1704 may be configured to generate a data unit including a plurality of fields including control information and a plurality of data symbols.

Returning to the description of FIG. 17, the apparatus 1602t may further include a digital to analog converter 1706 configured to convert the output of the transform module into an analog signal. For example, the time-domain output of the transform module 1704 may be converted to a baseband OFDM signal by the digital to analog converter 1706. The digital to analog converter 1706 may be implemented in the processing system 1604 or in another element of the apparatus 1602 of FIG. 16. In some aspects, the digital to analog converter 1706 is implemented in the transceiver 1614 (FIG. 16) or in a data transmit processor.

The analog signal may be wirelessly transmitted by the transmitter 1710. The analog signal may be further processed before being transmitted by the transmitter 1710, for example by being filtered or by being upconverted to an intermediate or carrier frequency. In the aspect illustrated in FIG. 17, the transmitter 1710 includes a transmit amplifier 1708. Prior to being transmitted, the analog signal may be amplified by the transmit amplifier 1708. In some aspects, the amplifier 1708 may (e.g., may be) include a low noise amplifier (LNA).

The transmitter 1710 is configured to transmit one or more packets or data units in a wireless signal based on the analog signal. The data units may be generated using the processing system 1604 (FIG. 16) and/or the DSP 1720, for example using the modulator 1702 and the transform module 1704 as discussed above. Data units that may be generated and transmitted as discussed above are described in additional detail below.

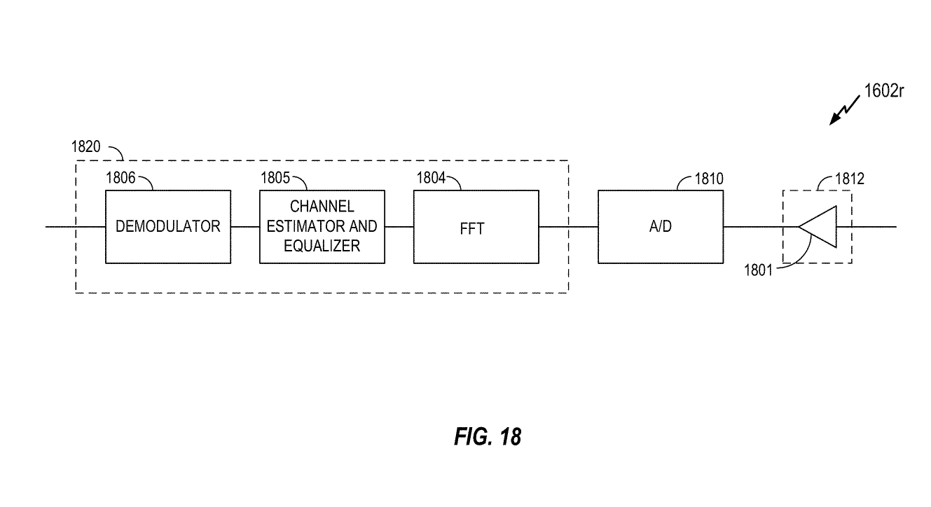

FIG. 18 illustrates various components that may be utilized in the apparatus 1602 of FIG. 16 to receive wireless communication. The components illustrated in FIG. 18 may be used, for example, to receive OFDM communication. For example, the components illustrated in FIG. 18 may be used to receive data units transmitted by the components discussed above with respect to FIG. 17.

The receiver 1812 of apparatus 1602r is configured to receive one or more packets or data units in a wireless signal. Data units that may be received and decoded or otherwise processed as discussed below.

In the aspect illustrated in FIG. 18, the receiver 1812 includes a receive amplifier 1801. The receive amplifier 1801 may be configured to amplify the wireless signal received by the receiver 1812. In some aspects, the receiver 1812 is configured to adjust the gain of the receive amplifier 1801 using an automatic gain control (AGC) procedure. In some aspects, the automatic gain control uses information in one or more received training fields, such as a received short training field (STF) for example, to adjust the gain. Those having ordinary skill in the art will understand methods for performing AGC. In some aspects, the amplifier 1801 may (e.g., may be) include an LNA.

The apparatus 1602r may include an analog to digital converter 1810 configured to convert the amplified wireless signal from the receiver 1812 into a digital representation thereof. Further to being amplified, the wireless signal may be processed before being converted by the analog to digital converter 1810, for example by being filtered or by being downconverted to an intermediate or baseband frequency. The analog to digital converter 1810 may be implemented in the processing system 1604 (FIG. 16) or in another element of the apparatus 1602r. In some aspects, the analog to digital converter 1810 is implemented in the transceiver 1614 (FIG. 16) or in a data receive processor.

The apparatus 1602r may further include a transform module 1804 configured to convert the representation of the wireless signal into a frequency spectrum. In FIG. 18, the transform module 1804 is illustrated as being implemented by a fast Fourier transform (FFT) module. In some aspects, the transform module may identify a symbol for each point that it uses. As described above with reference to FIG. 17, the transform module 1804 may be configured with a plurality of modes, and may use a different number of points to convert the signal in each mode. The number of points used by the transform module 1804 may be referred to as the size of the transform module 1804. In some aspects, the transform module 1804 may identify a symbol for each point that it uses.

The apparatus 1602r may further include a channel estimator and equalizer 1805 configured to form an estimate of the channel over which the data unit is received, and to remove certain effects of the channel based on the channel estimate. For example, the channel estimator and equalizer 1805 may be configured to approximate a function of the channel, and the channel equalizer may be configured to apply an inverse of that function to the data in the frequency spectrum.

The apparatus 1602r may further include a demodulator 1806 configured to demodulate the equalized data. For example, the demodulator 1806 may determine a plurality of bits from symbols output by the transform module 1804 and the channel estimator and equalizer 1805, for example by reversing a mapping of bits to a symbol in a constellation. The bits may be processed or evaluated by the processing system 1604 (FIG. 16), or used to display or otherwise output information to the user interface 1622 (FIG. 16). In this way, data and/or information may be decoded. In some aspects, the bits correspond to codewords. In one aspect, the demodulator 1806 may include (e.g., may be) a QAM (quadrature amplitude modulation) demodulator, for example an 8-QAM demodulator or a 64-QAM demodulator. In other aspects, the demodulator 1806 may include (e.g., may be) a binary phase-shift keying (BPSK) demodulator or a quadrature phase-shift keying (QPSK) demodulator.

In FIG. 18, the transform module 1804, the channel estimator and equalizer 1805, and the demodulator 1806 are illustrated as being implemented in the DSP 1820. In some aspects, however, one or more of the transform module 1804, the channel estimator and equalizer 1805, and the demodulator 1806 are implemented in the processing system 1604 (FIG. 16) or in another element of the apparatus 1602 (FIG. 16).

As discussed above, the wireless signal received at the receiver 1612 may include one or more data units. Using the functions or components described above, the data units or data symbols therein may be decoded evaluated or otherwise evaluated or processed. For example, the processing system 1604 (FIG. 16) and/or the DSP 1820 may be used to decode data symbols in the data units using the transform module 1804, the channel estimator and equalizer 1805, and the demodulator 1806.

Data units exchanged by the AP 1504 and the STA 1506 may include control information or data, as discussed above. At the physical (PHY) layer, these data units may be referred to as physical layer protocol data units (PPDUs). In some aspects, a PPDU may be referred to as a packet or physical layer packet. Each PPDU may include a preamble and a payload. The preamble may include training fields and a SIG field. The payload may include a Media Access Control (MAC) header or data for other layers, and/or user data, for example. The payload may be transmitted using one or more data symbols. The systems, methods, and devices herein may utilize data units with training fields whose peak-to-power ratio has been minimized

The apparatus 1602t shown in FIG. 17 is an example of a single transmit chain used for transmitting via an antenna. The apparatus 1602r shown in FIG. 18 is an example of a single receive chain used for receiving via an antenna. In some implementations, the apparatus 1602t or 1602r may implement a portion of a MIMO system using multiple antennas to simultaneously transmit data.

The wireless communication system 1500 may employ methods to allow efficient access of the wireless medium based on unpredictable data transmissions while avoiding collisions. As such, in accordance with various aspects, the wireless communication system 1500 performs carrier sense multiple access/collision avoidance (CSMA/CA) that may be referred to as the Distributed Coordination Function (DCF). More generally, an apparatus 1602 having data for transmission senses the wireless medium to determine if the channel is already occupied. If the apparatus 1602 senses the channel is idle, then the apparatus 1602 transmits prepared data. Otherwise, the apparatus 1602 may defer for some period before determining again whether or not the wireless medium is free for transmission. A method for performing CSMA may employ various gaps between consecutive transmissions to avoid collisions. In an aspect, transmissions may be referred to as frames and a gap between frames is referred to as an Interframe Spacing (IFS). Frames may be any one of user data, control frames, management frames, and the like.

IFS time durations may vary depending on the type of time gap provided. Some examples of IFS include a Short Interframe Spacing (SIFS), a Point Interframe Spacing (PIFS), and a DCF Interframe Spacing (DIFS) where SIFS is shorter than PIFS, which is shorter than DIFS. Transmissions following a shorter time duration will have a higher priority than one that must wait longer before attempting to access the channel

A wireless apparatus may include various components that perform functions based on signals that are transmitted by or received at the wireless apparatus. For example, in some implementations a wireless apparatus may include a user interface configured to output an indication based on a received signal as taught herein.

A wireless apparatus as taught herein may communicate via one or more wireless communication links that are based on or otherwise support any suitable wireless communication technology. For example, in some aspects a wireless apparatus may associate with a network such as a local area network (e.g., a Wi-Fi network) or a wide area network. To this end, a wireless apparatus may support or otherwise use one or more of a variety of wireless communication technologies, protocols, or standards such as, for example, Wi-Fi, WiMAX, CDMA, TDMA, OFDM, and OFDMA. Also, a wireless apparatus may support or otherwise use one or more of a variety of corresponding modulation or multiplexing schemes. A wireless apparatus may thus include appropriate components (e.g., air interfaces) to establish and communicate via one or more wireless communication links using the above or other wireless communication technologies. For example, a device may include a wireless transceiver with associated transmitter and receiver components that may include various components (e.g., signal generators and signal processors) that facilitate communication over a wireless medium.

The teachings herein may be incorporated into (e.g., implemented within or performed by) a variety of apparatuses (e.g., nodes). In some aspects, an apparatus (e.g., a wireless apparatus) implemented in accordance with the teachings herein may be implemented as an access point, a relay, or a STA.

A relay may include, be implemented as, or known as a relay node, a relay device, a relay station, a relay apparatus, or some other similar terminology. As discussed above, in some aspects, a relay may include some STA functionality and some access point functionality.

In some aspects, a wireless apparatus may be implemented as an access device (e.g., an access point) for a communication system. Such an access device provides, for example, connectivity to another network (e.g., a wide area network such as the Internet or a cellular network) via a wired or wireless communication link. Accordingly, the access device enables another device (e.g., a wireless station) to access the other network or some other functionality. In addition, it should be appreciated that one or both of the devices may be portable or, in some cases, relatively non-portable. Also, it should be appreciated that a wireless apparatus also may be capable of transmitting and/or receiving information in a non-wireless manner (e.g., via a wired connection) via an appropriate communication interface.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communication (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named 3^{rd} Generation Partnership Project (3GPP), while cdma2000 is described in documents from an organization named 3^{rd} Generation Partnership Project 2 (3GPP2). Although certain aspects of the disclosure may be described using 3GPP terminology, it is to be understood that the teachings herein may be applied to 3GPP (e.g., Rel99, Rel5, Rel6, Rel7) technology, as well as 3GPP2 (e.g., 1×RTT, 1×EV-DO Rel0, RevA, RevB) technology and other technologies.

### Example Communication Device

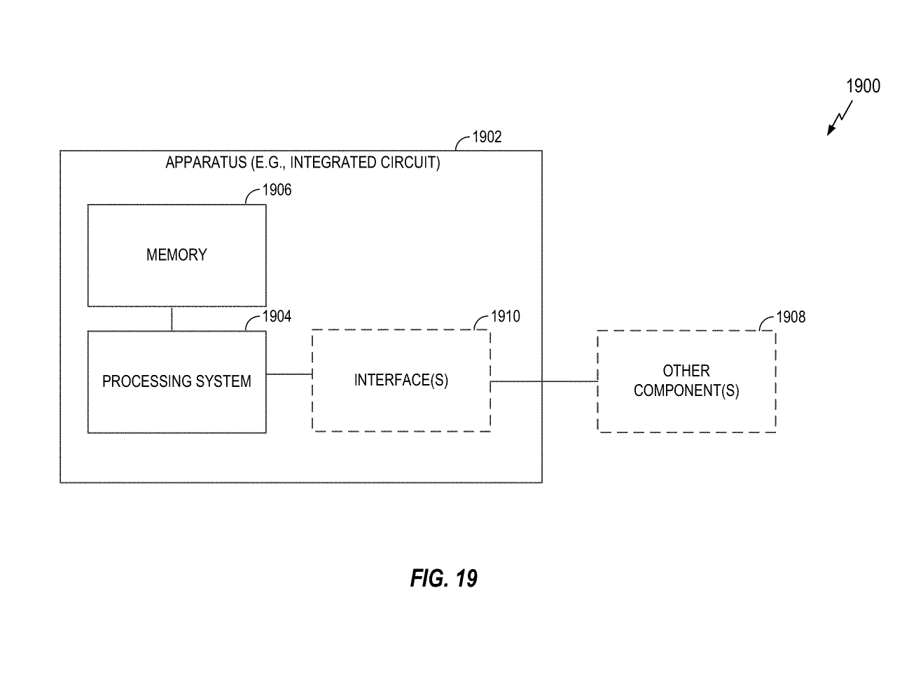

FIG. 19 illustrates an example apparatus 1900 (e.g., an AP, a STA, or some other type of wireless communication node) according to certain aspects of the disclosure. The apparatus 1900 includes an apparatus 1902 (e.g., an integrated circuit) and, optionally, at least one other component 1908. In some aspects, the apparatus 1902 may be configured to operate in a wireless communication node (e.g., an AP or a STA) and to perform one or more of the operations described herein. For convenience, a wireless communication node may be referred to herein as a wireless node. In different scenarios, a wireless node may be an AP, a STA, a central scheduler, or some other type of communication node. The apparatus 1902 includes a processing system 1904, and a memory 1906 coupled to the processing system 1904. Example implementations of the processing system 1904 are provided herein. In some aspects, the processing system 1904 and the memory 1906 of FIG. 19 may correspond to the processing system 1604 and the memory component 1606 of FIG. 16.

The processing system 1904 is generally adapted for processing, including the execution of such programming stored on the memory 1906. For example, the memory 1906 may store instructions that, when executed by the processing system 1904, cause the processing system 1904 to perform one or more of the operations described herein. As used herein, the terms “programming” or “instructions” or “code” shall be construed broadly to include without limitation instruction sets, instructions, data, code, code segments, program code, programs, programming, subprograms, software modules, applications, software applications, software packages, routines, subroutines, objects, executables, threads of execution, procedures, functions, etc., whether referred to as software, firmware, middleware, microcode, hardware description language, or otherwise.

In some implementations, the apparatus 1902 communicates with at least one other component (i.e., the at least one other component 1908 external to the apparatus 1902) of the apparatus 1900. To this end, in some implementations, the apparatus 1902 may include at least one interface 1910 (e.g., a send/receive interface) coupled to the processing system 1904 for outputting and/or obtaining (e.g., sending and/or receiving) information (e.g., received information, generated information, decoded information, messages, etc.) between the processing system 1904 and the at least one other component 1908. In some implementations, the at least one interface 1910 (i.e., including interface circuitry) may include an interface bus, bus drivers, bus receivers, other suitable circuitry, or a combination thereof. In some implementations, the at least one interface 1910 may include radio frequency (RF) circuitry (e.g., an RF transmitter and/or an RF receiver). In some implementations, the at least one interface 1910 may be configured to interface the apparatus 1902 to one or more other components of the apparatus 1900 (other components not shown in FIG. 19). For example, the at least one interface 1910 may be configured to interface the processing system 1904 to a radio frequency (RF) front end (e.g., an RF transmitter and/or am RF receiver).

The apparatus 1902 may communicate with other apparatuses in various ways. In cases where the apparatus 1902 includes an RF transceiver (not shown in FIG. 19), the apparatus may transmit and receive information (e.g. a frame, a message, bits, etc.) via RF signaling. In some cases, rather than transmitting information via RF signaling, the apparatus 1902 may have an interface to provide (e.g., output, send, transmit, etc.) information for RF transmission. For example, the processing system 1904 may output information, via a bus interface, to an RF front end for RF transmission. Similarly, rather than receiving information via RF signaling, the apparatus 1902 may have an interface to obtain information that is received by another apparatus. For example, the processing system 1904 may obtain (e.g., receive) information, via a bus interface, from an RF receiver that received the information via RF signaling. In some implementations, an interface may include multiple interfaces. For example, a bidirectional interface may include a first interface for obtaining and a second interface for outputting.

### Example Processes

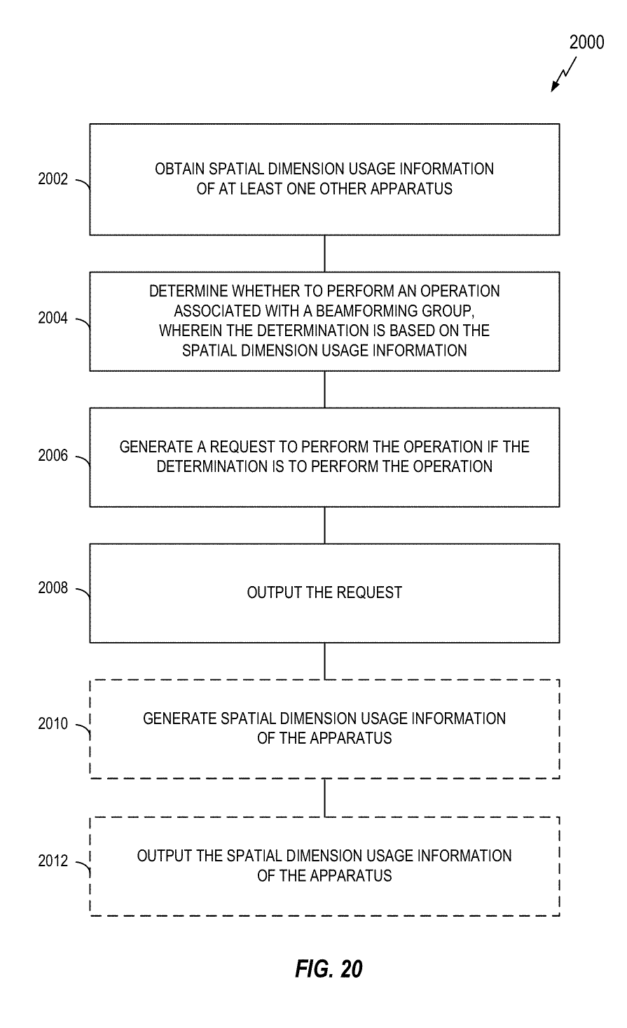

FIG. 20 illustrates a process 2000 for communication in accordance with some aspects of the disclosure. The process 2000 may take place within a processing system (e.g., the processing system 1904 of FIG. 19), which may be located in an AP, a STA, or some other suitable apparatus. Of course, in various aspects within the scope of the disclosure, the process 2000 may be implemented by any suitable apparatus capable of supporting communication-related operations.

At block 2002, an apparatus (e.g., a chip or a wireless node that is currently receiving) obtains spatial dimension usage information of at least one other apparatus. In some aspects, obtaining the information may involve a chip acquiring the information from another device (e.g., from a receiver that received the data). In some aspects, obtaining the information may involve a wireless node or receiver receiving the information.

The spatial dimension usage information (e.g., type one, two, three, or four discussed above) may take different forms in different implementations. In some aspects, the spatial dimension usage corresponds to a quantity of transmitted spatial streams and/or received spatial streams at an apparatus (e.g., an AP) across different time slots. In some aspects, the spatial dimension usage information may indicate a quantity of spatial dimensions to be used with a nulling procedure. In some aspects, the spatial dimension usage information may indicate a quantity of spatial dimensions to be used to serve at least one wireless node for which at least one transmission by at least one access point of the coordinate beamforming group results in unacceptable receive signal quality at the at least one wireless node. In some aspects, the spatial dimension usage information may indicate a mean quantity of spatial dimensions used during a time period, a maximum quantity of spatial dimensions used during a time period, a certain percentile of spatial dimensions used during a time period, a maximum quantity of spatial dimensions at the apparatus, or any combination thereof.

At block 2004, the apparatus determines whether to perform an operation associated with a beamforming group (e.g., a coordinated beamforming group). In some aspects, this determination may be based on the spatial dimension usage information.

In some aspects, the determination of whether to perform the operation may include determining whether to form the beamforming group. In this case, the determination of whether to form the beamforming group may include determining whether spatial dimension usage (e.g., total spatial dimension usage) for a plurality of access points would be increased if the beamforming group includes the plurality of access points. For example, the apparatus may elect to form the beamforming group if the spatial dimension usage for the plurality of access points would be increased.

In some aspects, the determination of whether to perform the operation may include determining whether to join the beamforming group. In this case, the determination of whether to join the beamforming group may include determining whether spatial dimension usage (e.g., total spatial dimension usage) for the apparatus would be increased if the beamforming group includes the apparatus. For example, the apparatus may elect to join the beamforming group if the spatial dimension usage for the apparatus would be increased.

In some aspects, the determination of whether to perform the operation may include determining whether to leave the beamforming group. In this case, the determination of whether to leave the beamforming group may include determining whether spatial dimension usage meets a threshold for the apparatus (e.g., is greater than or equal to the threshold in some scenarios; or is less than or equal to the threshold in other scenarios) if the beamforming group does not include the apparatus. For example, the apparatus may elect to leave the beamforming group if the spatial dimension usage meets the threshold.

At block 2006, the apparatus generates a request to perform the operation if the determination is to perform the operation. If the determination of block 2004 results in a determination to form the beamforming group, the generation of the request may include generating a request to form the beamforming group. If the determination of block 2004 results in a determination to join the beamforming group, the generation of the request may include generating a request to join the beamforming group. If the determination of block 2004 results in a determination to leave the beamforming group, the generation of the request may therefore include generating a request to leave the beamforming group.

At block 2008, the apparatus outputs the request. In some aspects, outputting the request may involve a chip sending the request to another device. In some aspects, outputting the request may involve a chip outputting the request for transmission by another device (e.g., by a transmitter). In some aspects, outputting the request may involve a wireless node or a transmitter transmitting the request.

At optional block 2010, the apparatus may generate spatial dimension usage information of the apparatus.

At optional block 2012, the apparatus may output the spatial dimension usage information. In some aspects, outputting the information may involve a chip sending the information to another device. In some aspects, outputting the information may involve a chip outputting the information for transmission by another device (e.g., by a transmitter). In some aspects, outputting the information may involve a wireless node or a transmitter transmitting the information.

In some aspects, a process in accordance with the teachings herein may include any combination of the operations of the process 2000.

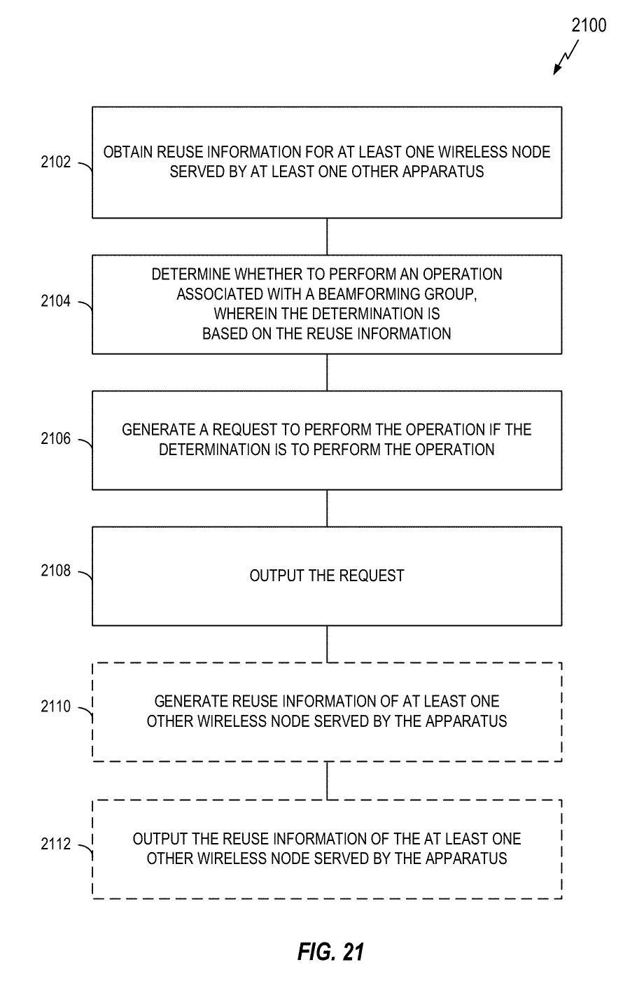

FIG. 21 illustrates a process 2100 for communication in accordance with some aspects of the disclosure. The process 2100 may take place within a processing system (e.g., the processing system 1904 of FIG. 19), which may be located in an AP, a STA, or some other suitable apparatus. Of course, in various aspects within the scope of the disclosure, the process 2100 may be implemented by any suitable apparatus capable of supporting communication-related operations.

At block 2102, an apparatus (e.g., a chip or a wireless node that is currently receiving) obtains reuse information of at least one wireless node served by at least one other apparatus. In some aspects, obtaining the information may involve a chip acquiring the information from another device (e.g., from a receiver that received the data). In some aspects, obtaining the information may involve a wireless node or receiver receiving the information.

The reuse information may take different forms in different implementations. In some aspects, the spatial dimension usage information may indicate a quantity of wireless nodes that can be served during a particular time slot without using a nulling procedure. In some aspects, the spatial dimension usage information may indicate a quantity of wireless nodes that would have acceptable receive signal quality during a particular time slot if the at least one other apparatus used the particular time slot.

At block 2104, the apparatus determines whether to perform an operation associated with a beamforming group. In some aspects, this determination may be based on the reuse information.

In some aspects, the determination of whether to perform the operation may include determining whether to form the beamforming group. In this case, the determination of whether to form the beamforming group may include determining whether spatial dimension usage (e.g., total spatial dimension usage) for access points of the beamforming group would be increased by forming the beamforming group. For example, the apparatus may elect to form the beamforming group if the spatial dimension usage for the plurality of access points would be increased. In some aspects, the determination of whether to form the beamforming group may include determining whether at least one wireless node per basis service set (BSS) can reuse a time slot with the at least one other apparatus. For example, the apparatus may elect to form the beamforming group if the time slot can be reused (e.g., at least one wireless node per basis service set can reuse the time slot).

In some aspects, the determination of whether to perform the operation may include determining whether to join the beamforming group. In this case, the determination of whether to join the beamforming group may include determining whether spatial dimension usage (e.g., total spatial dimension usage) for the apparatus would be increased by joining the beamforming group. For example, the apparatus may elect to join the beamforming group if the spatial dimension usage for the apparatus would be increased.

In some aspects, the determination of whether to perform the operation may include determining whether to leave the beamforming group. In this case, the determination of whether to leave the beamforming group may include determining whether spatial dimension usage meets a threshold for the apparatus (e.g., is greater than or equal to the threshold in some scenarios; or is less than or equal to the threshold in other scenarios) if the apparatus leaves the beamforming group. For example, the apparatus may elect to leave the beamforming group if the spatial dimension usage meets the threshold.

At block 2106, the apparatus generates a request to perform the operation if the determination is to perform the operation. If the determination of block 2104 results in a determination to form the beamforming group, the generation of the request may include generating a request to form the beamforming group. If the determination of block 2104 results in a determination to join the beamforming group, the generation of the request may include generating a request to join the beamforming group. If the determination of block 2104 results in a determination to leave the beamforming group, the generation of the request may therefore include generating a request to leave the beamforming group.

At block 2108, the apparatus outputs the request. In some aspects, outputting the request may involve a chip sending the request to another device. In some aspects, outputting the request may involve a chip outputting the request for transmission by another device (e.g., by a transmitter). In some aspects, outputting the request may involve a wireless node or a transmitter transmitting the request.

At optional block 2110, the apparatus may generate reuse information of the at least one other wireless node served by the apparatus.

At optional block 2112, the apparatus may output the reuse information of the at least one other wireless node that was generated at block 2110. In some aspects, outputting the information may involve a chip sending the information to another device. In some aspects, outputting the information may involve a chip outputting the information for transmission by another device (e.g., by a transmitter). In some aspects, outputting the information may involve a wireless node or a transmitter transmitting the information.

In some aspects, a process in accordance with the teachings herein may include any combination of the operations of the process 2100.

### Example Apparatus

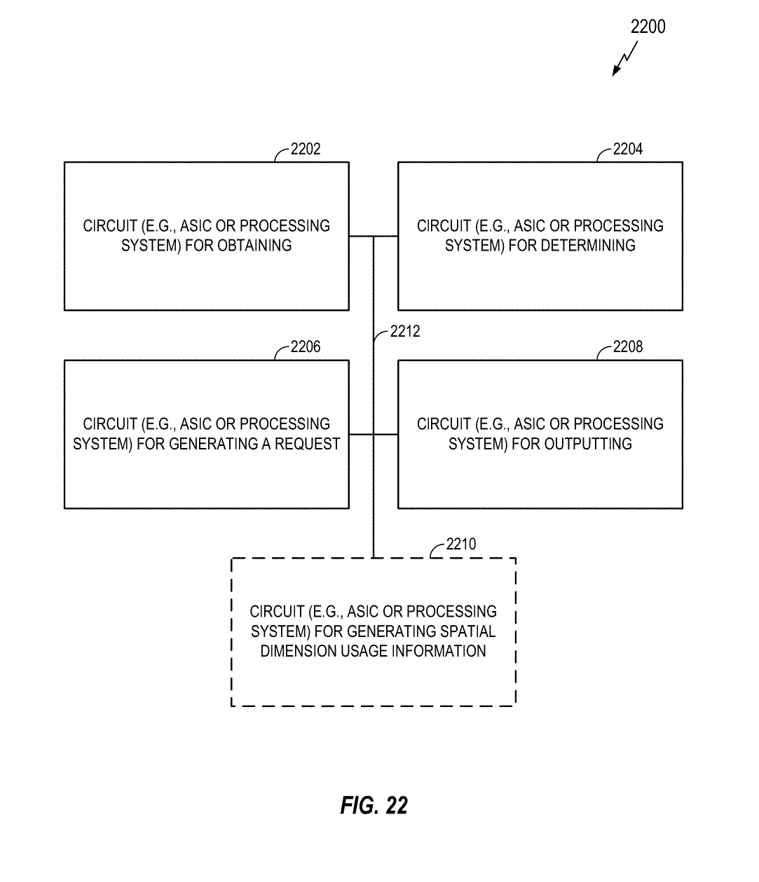

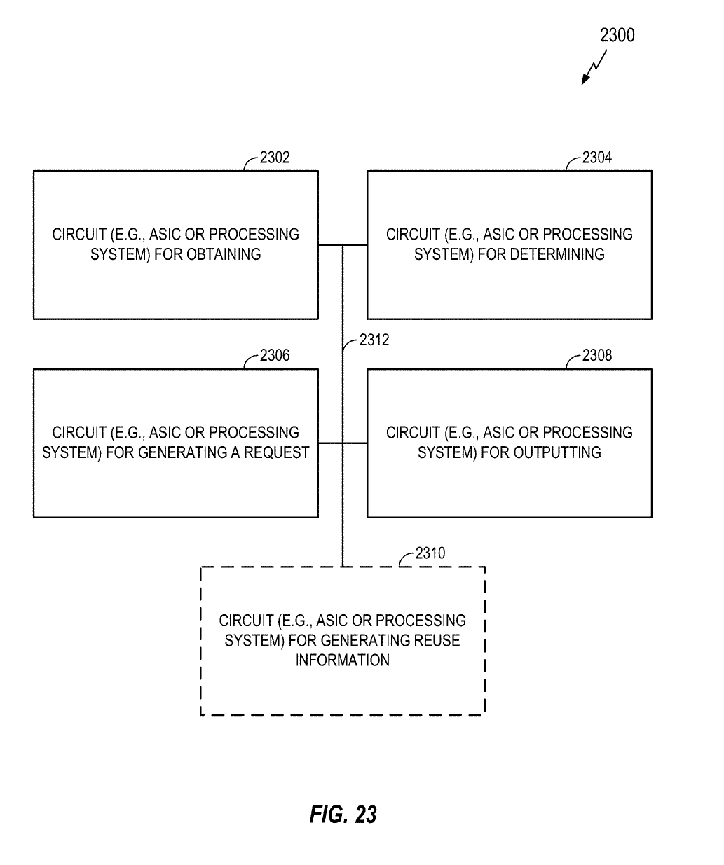

The components described herein may be implemented in a variety of ways. Referring to FIGS. 22 and 23, apparatuses 2200 and 2300 are represented as a series of interrelated functional blocks that represent functions implemented by, for example, one or more integrated circuits (e.g., an ASIC) or implemented in some other manner as taught herein. As discussed herein, an integrated circuit may include a processor, software, other components, or some combination thereof.

The apparatus 2200 includes one or more components (modules) that may perform one or more of the functions described herein with regard to various figures. For example, a circuit (e.g., an ASIC or processing system) for obtaining 2202, e.g., a means for obtaining, may correspond to, for example, an interface (e.g., a bus interface, a send/receive interface, or some other type of signal interface), a communication device, a transceiver, a receiver, or some other similar component as discussed herein. A circuit (e.g., an ASIC or processing system) for determining 2204, e.g., a means for determining, may correspond to, for example, a processing system as discussed herein. A circuit (e.g., an ASIC or processing system) for generating a request 2206, e.g., a means for generating a request, may correspond to, for example, a processing system as discussed herein. A circuit (e.g., an ASIC or processing system) for outputting 2208, e.g., a means for outputting, may correspond to, for example, an interface (e.g., a bus interface, a send/receive interface, or some other type of signal interface), a communication device, a transceiver, a transmitter, or some other similar component as discussed herein. A circuit (e.g., an ASIC or processing system) for generating spatial dimension usage information 2210, e.g., a means for generating spatial dimension usage information, may correspond to, for example, a processing system as discussed herein. Two or more of the modules of FIG. 22 may communicate with each other or some other component via a signaling bus 2212. In various implementations, the processing system 1604 of FIG. 16 and/or the processing system 1904 of FIG. 19 may include one or more of the circuit for obtaining 2202, the circuit for determining 2204, the circuit for generating a request 2206, the circuit for outputting 2208, or the circuit for generating spatial dimension usage information 2210.

The apparatus 2300 includes one or more components (modules) that may perform one or more of the functions described herein with regard to various figures. For example, a circuit (e.g., an ASIC or processing system) for obtaining 2302, e.g., a means for obtaining, may correspond to, for example, an interface (e.g., a bus interface, a send/receive interface, or some other type of signal interface), a communication device, a transceiver, a receiver, or some other similar component as discussed herein. A circuit (e.g., an ASIC or processing system) for determining 2304, e.g., a means for determining, may correspond to, for example, a processing system as discussed herein. A circuit (e.g., an ASIC or processing system) for generating a request 2306, e.g., a means for generating a request, may correspond to, for example, a processing system as discussed herein. A circuit (e.g., an ASIC or processing system) for outputting 2308, e.g., a means for outputting, may correspond to, for example, an interface (e.g., a bus interface, a send/receive interface, or some other type of signal interface), a communication device, a transceiver, a transmitter, or some other similar component as discussed herein. A circuit (e.g., an ASIC or processing system) for generating reuse information 2310, e.g., a means for generating reuse information, may correspond to, for example, a processing system as discussed herein. Two or more of the modules of FIG. 23 may communicate with each other or some other component via a signaling bus 2312. In various implementations, the processing system 1604 of FIG. 16 and/or the processing system 1904 of FIG. 19 may include one or more of the circuit for obtaining 2302, the circuit for determining 2304, the circuit for generating a request 2306, the circuit for outputting 2308, or the circuit for generating reuse information 2310.

As noted above, in some aspects these modules may be implemented via appropriate processor components. These processor components may in some aspects be implemented, at least in part, using structure as taught herein. In some aspects, a processor may be configured to implement a portion or all of the functionality of one or more of these modules. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module. In some aspects one or more of any components represented by dashed boxes in FIG. 22, FIG. 23, or elsewhere herein are optional.

As noted above, the apparatuses 2200 and 2300 include one or more integrated circuits in some implementations. For example, in some aspects a single integrated circuit implements the functionality of one or more of the illustrated components, while in other aspects more than one integrated circuit implements the functionality of one or more of the illustrated components. As one specific example, the apparatus 2200 may be implemented as a single device (e.g., with the circuit for obtaining 2202, the circuit for determining 2204, the circuit for generating a request 2206, the circuit for outputting 2208, and the circuit for generating spatial dimension usage information 2210 implemented in different sections of an ASIC). As another specific example, the apparatus 2200 may be implemented as several devices (e.g., with the circuit for obtaining 2202 and the circuit for outputting 2208 implemented in one ASIC, and the circuit for determining 2204, the circuit for generating a request 2206, and the circuit for generating spatial dimension usage information 2210 implemented in another ASIC).

In addition, the components and functions represented by FIGS. 22 and 23 as well as other components and functions described herein, may be implemented using any suitable means. Such means are implemented, at least in part, using corresponding structure as taught herein. For example, the components described above in conjunction with the “ASIC for” components of FIGS. 22 and 23 correspond to similarly designated “means for” functionality. Thus, one or more of such means is implemented using one or more of processor components, integrated circuits, or other suitable structure as taught herein in some implementations.

The various operations of methods described herein may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar functionality and/or numbering. For example, the blocks of the process 2000 illustrated in FIG. 20 may correspond at least in some aspects, to corresponding blocks of the apparatus 2200 illustrated in FIG. 22. As another example, the blocks of the process 2100 illustrated in FIG. 21 may correspond at least in some aspects, to corresponding blocks of the apparatus 2300 illustrated in FIG. 23.

### Example Programming

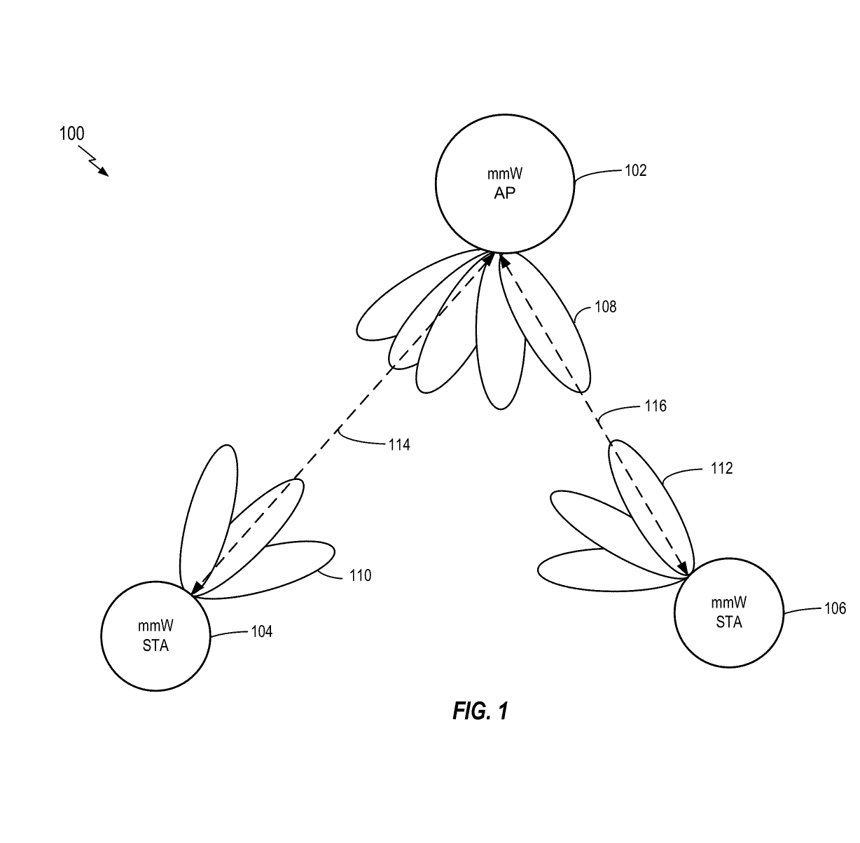

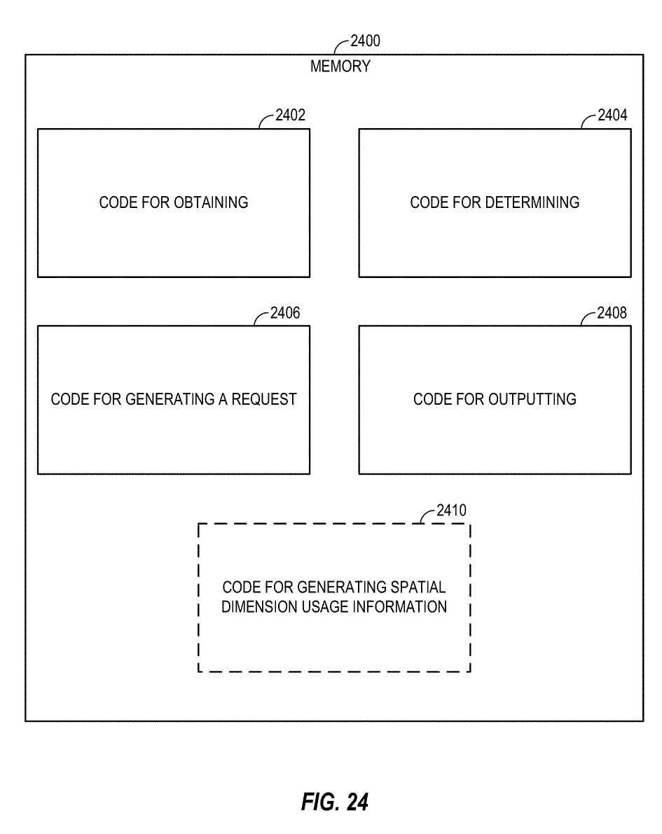

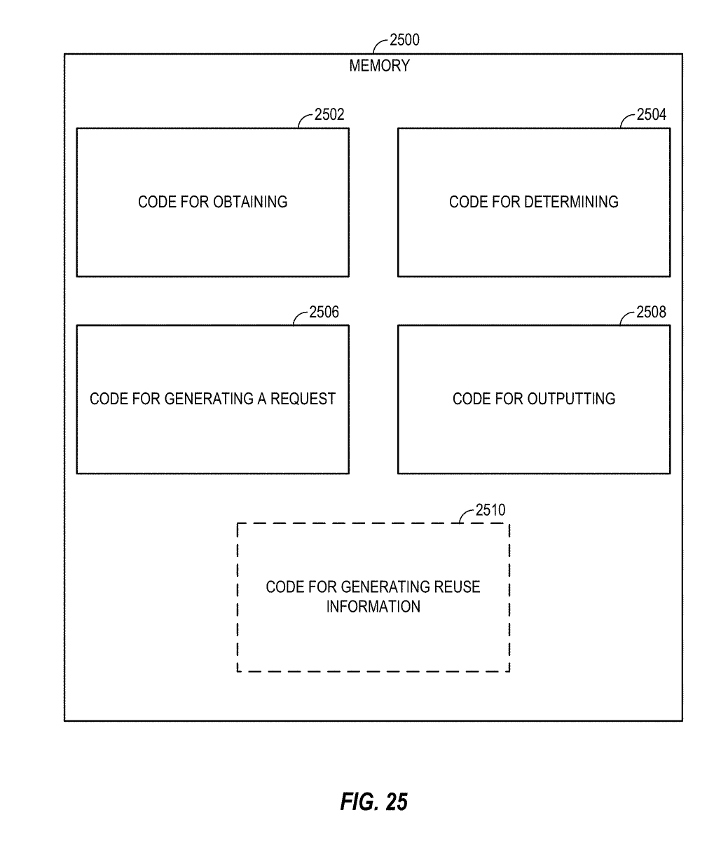

Referring to FIGS. 24 and 25, programming stored by the memory 2400 or 2500 (e.g. a storage medium, a memory device, etc.), when executed by a processing system (e.g., the processing system 1904 of FIG. 19), causes the processing system to perform one or more of the various functions and/or process operations described herein. For example, the programming, when executed by the processing system 1904, may cause the processing system 1904 to perform the various functions, steps, and/or processes described herein with respect to FIGS. 1-14, 20, and 21 in various implementations.

As shown in FIG. 24, the memory 2400 may include one or more of code for obtaining 2402, code for determining 2404, code for generating a request 2406, code for outputting 2408, or code for generating spatial dimension information 2410. In some aspects, one of more of the code for obtaining 2402, the code for determining 2404, the code for generating a request 2406, the code for outputting 2408, or the code for generating spatial dimension information 2410 may be executed or otherwise used to provide the functionality described herein for the circuit for obtaining 2202, the circuit for determining 2204, the circuit for generating a request 2206, the circuit for outputting 2208, or the circuit for generating spatial dimension usage information 2210 of FIG. 22. In some aspects, the memory 2400 may correspond to the memory 1906 of FIG. 19.

As shown in FIG. 25, the memory 2500 may include one or more of code for obtaining 2502, code for determining 2504, code for generating a request 2506, code for outputting 2508, or code for generating reuse information 2510. In some aspects, one of more of the code for obtaining 2502, the code for determining 2504, the code for generating a request 2506, the code for outputting 2508, or the code for generating reuse information 2510 may be executed or otherwise used to provide the functionality described herein for the circuit for obtaining 2302, the circuit for determining 2304, the circuit for generating a request 2306, the circuit for outputting 2308, or the circuit for generating reuse information 2310 of FIG. 23. In some aspects, the memory 2500 may correspond to the memory 1906 of FIG. 19.

### Additional Aspects

The examples set forth herein are provided to illustrate certain concepts of the disclosure. Those of ordinary skill in the art will comprehend that these are merely illustrative in nature, and other examples may fall within the scope of the disclosure and the appended claims. Based on the teachings herein those skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

As those skilled in the art will readily appreciate, various aspects described throughout this disclosure may be extended to any suitable telecommunication system, network architecture, and communication standard. By way of example, various aspects may be applied to wide area networks, peer-to-peer network, local area network, other suitable systems, or any combination thereof, including those described by yet-to-be defined standards.

Many aspects are described in terms of sequences of actions to be performed by, for example, elements of a computing device. It will be recognized that various actions described herein can be performed by specific circuits, for example, central processing units (CPUs), graphic processing units (GPUs), digital signal processors (DSPs), application specific integrated circuits (ASICs), field programmable gate arrays (FPGAs), or various other types of general purpose or special purpose processors or circuits, by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein (e.g., computer-readable medium storing computer-executable code, including code to perform the functionality described herein). Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

One or more of the components, steps, features and/or functions illustrated in above may be rearranged and/or combined into a single component, step, feature or function or embodied in several components, steps, or functions. Additional elements, components, steps, and/or functions may also be added without departing from novel features disclosed herein. The apparatus, devices, and/or components illustrated above may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An example of a storage medium is coupled to the processor such that the processor can read information from, and write information to, the storage medium. In the alternative, the storage medium may be integral to the processor.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage or mode of operation.

The terminology used herein is for the purpose of describing particular aspects only and is not intended to be limiting of the aspects. As used herein, the singular forms “a,” “an” and “the” are intended to include the plural forms as well, unless the context clearly indicates otherwise. It will be further understood that the terms “comprises,” “comprising,” “includes” or “including,” when used herein, specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “/” between two adjacent words has the same meaning as “or” unless expressly stated otherwise. Moreover, phrases such as “connected to,” “coupled to” or “in communication with” are not limited to direct connections unless expressly stated otherwise.

Any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be used there or that the first element must precede the second element in some manner Also, unless stated otherwise a set of elements may include one or more elements. In addition, terminology of the form “at least one of a, b, or c” or “one or more of a, b, or c” used in the description or the claims means “a or b or c or any combination of these elements.” For example, this terminology may include a, or b, or c, or a and b, or a and c, or a and b and c, or 2a, or 2b, or 2c, or 2a and b, and so on.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

While the foregoing disclosure shows illustrative aspects, it should be noted that various changes and modifications could be made herein without departing from the scope of the appended claims. The functions, steps or actions of the method claims in accordance with aspects described herein need not be performed in any particular order unless expressly stated otherwise. Furthermore, although elements may be described or claimed in the singular, the plural is contemplated unless limitation to the singular is explicitly stated.

1. An apparatus for communication, comprising:
an interface configured to obtain spatial dimension usage information of at least one other apparatus; and
a processing system configured to:
determine whether to perform an operation associated with a beamforming group, wherein the determination is based on the spatial dimension usage information, and
generate a request to perform the operation if the determination is to perform the operation,
wherein the interface is further configured to output the request for transmission.

2. The apparatus of claim 1, wherein the spatial dimension usage information indicates a quantity of spatial dimensions to be used with a nulling procedure.

3. The apparatus of claim 1, wherein:
the processing system is further configured to generate spatial dimension usage information of the apparatus; and
the interface is further configured to output the spatial dimension usage information of the apparatus for transmission.

4. The apparatus of claim 1, wherein the spatial dimension usage information indicates a mean quantity of spatial dimensions used during a time period, a maximum quantity of spatial dimensions used during a time period, a certain percentile of spatial dimensions used during a time period, a maximum quantity of spatial dimensions at the apparatus, or any combination thereof.

5. The apparatus of claim 1, wherein:
the determination of whether to perform the operation comprises determining whether to form the beamforming group; and
the generation of the request comprises generating a request to form the beamforming group if the determination is to form the beamforming group.

6. The apparatus of claim 5, wherein the determination of whether to form the beamforming group comprises:
determining whether spatial dimension usage for a plurality of access points would be increased if the beamforming group includes the plurality of access points; and
electing to form the beamforming group if the spatial dimension usage for the plurality of access points would be increased.

7. The apparatus of claim 1, wherein:
the determination of whether to perform the operation comprises determining whether to join the beamforming group; and
the generation of the request comprises generating a request to join the beamforming group if the determination is to join the beamforming group.

8. The apparatus of claim 7, wherein the determination of whether to join the beamforming group comprises:
determining whether spatial dimension usage for the apparatus would be increased if the beamforming group includes the apparatus; and
electing to join the beamforming group if the spatial dimension usage for the apparatus would be increased.

9. The apparatus of claim 1, wherein:
the determination of whether to perform the operation comprises determining whether to leave the beamforming group; and
the generation of the request comprises generating a request to leave the beamforming group if the determination is to leave the beamforming group.

10. The apparatus of claim 9, wherein the determination of whether to leave the beamforming group comprises:
determining whether spatial dimension usage meets a threshold for the apparatus if the beamforming group does not include the apparatus; and
electing to leave the beamforming group if the spatial dimension usage meets the threshold.

11-30. (canceled)

31. A wireless node, comprising:
a receiver configured to receive spatial dimension usage information of at least one other apparatus;
a processing system configured to:
determine whether to perform an operation associated with a beamforming group, wherein the determination is based on the spatial dimension usage information, and
generate a request to perform the operation if the determination is to perform the operation; and
a transmitter configured to transmit the request.

32. (canceled)

33. An apparatus for communication, comprising:
an interface configured to obtain reuse information of at least one wireless node served by at least one other apparatus; and
a processing system configured to:
determine whether to perform an operation associated with a beamforming group, wherein the determination is based on the reuse information, and
generate a request to perform the operation if the determination is to perform the operation,
wherein the interface is further configured to output the request for transmission.

34. The apparatus of claim 33, wherein the reuse information indicates a quantity of wireless nodes that can be served during a particular time slot without using a nulling procedure.

35. The apparatus of claim 33, wherein the reuse information indicates a quantity of wireless nodes that would have acceptable receive signal quality during a particular time slot if the at least one other apparatus uses the particular time slot.

36. The apparatus of claim 33, wherein:
the processing system is further configured to generate reuse information of at least one other wireless node served by the apparatus; and
the interface is further configured to output the reuse information of the at least one other wireless node for transmission.

37. The apparatus of claim 33, wherein:
the determination of whether to perform the operation comprises determining whether to form the beamforming group; and
the generation of the request comprises generating a request to form the beamforming group if the determination is to form the beamforming group.

38. The apparatus of claim 37, wherein the determination of whether to form the beamforming group comprises:
determining whether spatial dimension usage for access points of the beamforming group would be increased by forming the beamforming group; and
electing to form the beamforming group if the spatial dimension usage for the access points would be increased.

39. The apparatus of claim 37, wherein the determination of whether to form the beamforming group comprises:
determining whether at least one wireless node per basis service set can reuse a time slot with the at least one other apparatus; and
electing to form the beamforming group if the at least one wireless node per basis service set can reuse the time slot.

40. The apparatus of claim 33, wherein:
the determination of whether to perform the operation comprises determining whether to join the beamforming group; and
the generation of the request comprises generating a request to join the beamforming group if the determination is to join the beamforming group.

41. The apparatus of claim 40, wherein the determination of whether to join the beamforming group comprises:
determining whether spatial dimension usage for the apparatus would be increased by joining the beamforming group; and
electing to join the beamforming group if the spatial dimension usage for the apparatus would be increased.

42. The apparatus of claim 33, wherein:
the determination of whether to perform the operation comprises determining whether to leave the beamforming group; and
the generation of the request comprises generating a request to leave the beamforming group if the determination is to leave the beamforming group.

43. The apparatus of claim 42, wherein the determination of whether to leave the beamforming group comprises:
determining whether spatial dimension usage meets a threshold for the apparatus if the apparatus leaves the beamforming group; and
electing to leave the beamforming group if the spatial dimension usage meets the threshold.

44-67. (canceled)

68. The apparatus of claim 33, further comprising:
a receiver configured to receive the reuse information, wherein the interface is further configured to obtain the reuse information via the receiver; and
a transmitter configured to transmit the request,
wherein the apparatus is configured as a wireless node.
